(19) United States
(12) Patent Application Publication
(10) Pub. No.: US 2009/0260043 A1
(43) Pub. Date: Oct. 15, 2009

(54) WIRELESS TRANSMISSION SYSTEM FOR WIRELESSLY CONNECTING SIGNAL SOURCE APPARATUS AND SIGNAL SINK APPARATUS

(76) Inventors: Akihiro Tatsuta, Kyoto (JP); Yoshikane Nishikawa, Hyogo (JP); Makoto Funabiki, Osaka (JP); Hiroshi Ohue, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/088,832

(22) PCT Filed: Sep. 29, 2006
(86) PCT No.: PCT/JP2006/319484

§ 371 Date: Sep. 3, 2008

(30) Foreign Application Priority Data
Sep. 30, 2005 (JP) 2005-287136

(51) Int. Cl. H04N 7/18

(52) U.S. Cl. 725/81

(57) ABSTRACT

An adapter apparatus wirelessly transmits a TMDS signal to an adapter apparatus using a first radio channel, wirelessly transmits a DDC downstream signal and a CEC downstream signal to an adapter apparatus using a second radio channel, and receives a radio signal including a DDC upstream signal and a CEC upstream signal from the adapter apparatus using the second radio channel. The adapter apparatus receives the TMDS signal using the first radio channel, receives the radio signal including the DDC downstream signal and the CEC downstream signal using the second radio channel, and wirelessly transmits the DDC upstream signal and the CEC upstream signal to the adapter apparatus using the second radio channel.

### TECHNICAL FIELD

The present invention relates to a wireless communication apparatus and a wireless transmission system. In particular, the present invention relates to a wireless communication apparatus and a wireless transmission system for wirelessly transmitting an uncompressed baseband video signal and a digital audio signal reproduced and outputted by a signal source apparatus such as a DVD player and a set-top box, to a signal sink apparatus such as a digital television.

### BACKGROUND ART

The AV equipments adopting an HDMI (high-definition multimedia interface) standard have been in widespread use in the market. The HDMI standard is an interface standard for a next generation digital television capable of transmitting an uncompressed baseband video signal and a digital audio signal via one cable (for example, see Patent documents 1 and 2). Conventionally, it has been required to use transmission cables each transmitting a signal such as a video signal, an audio signal, or the like in order to connect AV equipments with each other. However, the AV equipments adopting the HDMI standard can be connected with each other via only one HDMI cable of a digital data transmission bus compliant with the HDMI standard. Accordingly, there is such an advantage that the interconnection between the AV equipments can be simplified as compared before. In addition, since data transmitted via the HDMI cable is digital data, there is such an advantage that the noise resistance is large and the image quality can be mage high. Further, since a control signal can be transmitted bi-directionally via the HDMI cable, it is possible to interlock a digital television apparatus with a DVD player, and to configure a home theater by connecting a plurality of AV equipments using the HDMI cables and controlling the whole operation of the home theater.

Outline of an HDMI system related to a prior art will be described below. In this case, the HDMI system includes an HDMI source apparatus of a signal source apparatus for transmitting and receiving a signal compliant with the HDMI standard, and an HDMI sink apparatus of a signal sink apparatus for transmitting and receiving the signal compliant with the HDMI standard. In the HDMI system, the HDMI source apparatus such as a DVD player and a set-top box is connected to the HDMI sink apparatus such as a liquid crystal display apparatus and a digital television apparatus via one HDMI cable. The HDMI source apparatus is provided with a transmitter circuit, and the HDMI sink apparatus is provided with a receiver circuit and an EDID (Extended Display Identification Data) memory. In this case, the EDID memory preliminarily stores EDID which is configuration information such as identification information, video output specifications, and audio output specifications of the HDMI sink apparatus.

The HDMI cable includes three TMDS (Transition Minimized Differential Signaling) channels, a TMDS clock channel, a DDC (Display Data Channel) channel, and a CEC (Consumer Electronics Control) line.

The DDC channel is a transmission path for transmitting a DDC downstream signal transmitted from the HDMI source apparatus to the HDMI sink apparatus, and a DDC upstream signal transmitted from the HDMI sink apparatus to the HDMI source apparatus. After reading out the EDID of the HDMI sink apparatus via the DDC channel, the HDMI source apparatus generates a baseband video signal having video output specifications of the HDMI sink apparatus read out from the EDID, a digital audio signal having audio output specifications of the HDMI sink apparatus, and auxiliary data, and thereafter, transmits the same signals and data to the HDMI sink apparatus via the three TMDS channels, as will described in detail below. In addition, when contents protection by HDCP (High-bandwidth Digital Content Protection) is performed, the DDC channel is used for HDCP authentication processing and periodic exchange of an encryption key.

On the other hand, the CEC line is a transmission path for transmitting a CEC downstream signal transmitted from the HDMI source apparatus to the HDMI sink apparatus, and a CEC upstream signal transmitted from the HDMI sink apparatus to the HDMI source apparatus, in order to control the HDMI source apparatus and the HDMI sink apparatus to operate with interlocking with each other. For example, in the case where the HDMI source apparatus is a DVD recorder and the HDMI sink apparatus is a digital television apparatus, when the digital television apparatus is reproducing a received television broadcasting signal, outputting the same signal to a display of the digital television apparatus and displaying the same signal thereon, the following operation can be performed. It is possible to control to automatically switch between inputted signals to the display, to display video and audio data outputted by the DVD recorder on the display, when the DVD recorder starts reproducing of contents. In addition, it is possible to start recording of a program by the DVD recorder with one-touch remote operation by a user, when the digital television apparatus is reproducing the received television-broadcasting signal.

In addition, the three TMDS channels are transmission paths for transmitting TMDS signals including video data, audio data, and auxiliary data from the HDMI source apparatus to the HDMI sink apparatus. First of all, a 24 bit/pixel baseband video signal, a digital audio signal, a horizontal synchronizing signal and a vertical synchronizing signal of the video signal, and auxiliary data are inputted to the transmitter circuit of the HDMI source apparatus, respectively. In this case, the 24-bit/pixel baseband video signal has predetermined specifications such as the RGB format or the YCbCr format. The digital audio signal has predetermined specifications such as a IEC 60958 audio stream at a sample rate of 32 kHz, 44.1 kHz, or 48 kHz, one channel of audio stream at a sample rate of up to 192 kHz, two to four channels of audio stream at a sample rate of up to 96 kHz, or an IEC 61937 compressed audio stream at a sample rate of up to 192 kHz. The auxiliary data includes audio clock information, InfoFrames (EIA/CEA-861B system), and the like.

Next, the transmitter circuit time-division-multiplexes the baseband video signal, the horizontal synchronizing signal and the vertical synchronizing signal, the digital audio signal, and the auxiliary data for a blanking interval of the video signal. In this case, a packet configuration is used for the digital audio signal and the auxiliary data use. Further, when copyright protection of the contents is required, encryption processing according to the HDCP is performed on the baseband video signal, the digital audio signal, and the auxiliary data. Then, 8B10B conversion processing for converting every 8-bit data into 10-bit data is performed on the baseband video signal. On the other hand, BCH error correction processing and 4B10B conversion processing for converting every 4-bit data into 10-bit data are performed on the digital audio signal and the auxiliary data. Further, parallel-to-serial conversion is performed on the converted 10-bit data to generate the TMDS signals, and the same signals are outputted to the HDMI sink apparatus via the three TMDS channels. Further, a pixel clock signal is outputted to the HDMI sink apparatus via the TMDS clock channel. In this case, the pixel rate has a rate value within a range of 25 MHz to 165 MHz, and the rate value is one-tenth of each transmission rate of the TMDS channel.

The receiver circuit of the HDMI sink apparatus decodes the TMDS signals from the three TMDS channels by performing serial-to-parallel conversion in synchronization with the pixel clock signal from the TMDS clock channel. Further, when the contents is encrypted, the receiver circuit performs HDCP decoding processing to generate the baseband video signal, the digital audio signal, the horizontal synchronizing signal of the video signal, the vertical synchronizing signal of the video signal, and the auxiliary data.

Patent Document 1 discloses a transmission system for transmitting an uncompressed baseband video signal and a digital audio signal included in the TMDS signal by optical wireless communication.

Patent Document 1: Japanese patent laid-open publication No. JP-2005-102161-A.

Patent Document 2: Japanese patent laid-open publication No. JP-2004-304220-A.

### DISCLOSURE OF THE INVENTION

### Problems to be Solved by the Invention

However, the HDMI system according to the prior arts has the following problems. When the HDMI source apparatus is a wall-hung type television apparatus or a projector apparatus attached to the ceiling, it is required to wire the HDMI cable along the wall to connect the HDMI source apparatus to the HDMI sink apparatus, and this leads to an extra effort and unsightly appearance. Further, the installation location and the handling range of the apparatuses are disadvantageously restricted by the lengths of the HDMI cable for connecting the apparatuses to each other. Further, it is difficult for a user unaccustomed to the operation of the AV apparatuses to correctly connect a plurality of AV apparatuses to each other using the cables.

In addition, the Patent Document 1 discloses the transmission system for transmitting the uncompressed baseband video signal and the digital audio signal by optical wireless communication, however, it is required to connect the AV apparatuses to each other using cables for transmitting the signals transmitted via the DDC channel and the CEC line, respectively. Accordingly, the transmission system has problems to similar those of the HDMI system according to the prior art.

An essential object of the present invention is to provide a wireless communication apparatus and a wireless transmission system capable of solving the foregoing problem, enhancing the flexibility of the installation locations of the HDMI source apparatus and the HDMI sink apparatus, and simplifying the connection between the HDMI source apparatus and the HDMI sink apparatus without using any HDMI cables as compared with the prior arts.

### Means for Solving the Problems

The wireless communication apparatus according to the first aspect of the present invention is a first wireless communication apparatus for transmitting a transmitting signal compliant with HDMI standard, and for receiving a received signal compliant with the HDMI standard, the transmitting signal including a TMDS signal, a DDC downstream signal, and a CEC downstream signal, the received signal including a DDC upstream signal and a CEC upstream signal. The wireless communication apparatus includes first and second wireless communication means. The first wireless communication means wirelessly transmits the TMDS signal as a first radio signal using a first radio channel. The second wireless communication means wirelessly transmits the DDC downstream signal and the CEC downstream signal as a second radio signal using a second radio channel, and receives a third radio signal including the DDC upstream signal and the CEC upstream signal using the second radio channel.

In the above-mentioned wireless communication apparatus, the second wireless communication means includes first time division multiplexing and demultiplexing means for time-division-multiplexing the DDC downstream signal and the CEC downstream signal into the second radio signal, and for time-division-demultiplexing the third radio signal into the DDC upstream signal and the CEC upstream signal.

In addition, in the above-mentioned wireless communication apparatus, the first time division multiplexing and demultiplexing means time-division-multiplexes the DDC downstream signal and the CEC downstream signal into the second radio signal with giving priority to the DDC downstream signal over the CEC downstream signal, so as to wirelessly transmit the DDC downstream signal prior to the CEC downstream signal.

Further, in the above-mentioned wireless communication apparatus, in either one of (a) a case where the DDC downstream signal includes a readout request signal for EDID information, and (b) a case where the DDC downstream signal includes a downstream signal of HDCP authentication processing based on the HDMI standard, the first time division multiplexing and demultiplexing means time-division-multiplexes the DDC downstream signal and the CEC downstream signal into the second radio signal with giving priority to the DDC downstream signal over the CEC downstream signal, so as to wirelessly transmit the DDC downstream signal prior to the CEC downstream signal.

Still further, in the above-mentioned wireless communication apparatus, the first wireless communication means wirelessly transmits a TMDS radio test signal including a predetermined reference pattern to a second wireless communication apparatus as the first radio signal using the first radio channel. In addition, the second wireless communication means receives a first estimation value relating to a first received state of the TMDS radio test signal detected by the second wireless communication apparatus as the third radio signal using the second radio channel. Further, the first wireless communication apparatus further includes control means for adjusting transmitting parameters of the first radio signal based on the first estimation value, so as to make the first received state substantially best.

In addition, in the above-mentioned wireless communication apparatus, the second wireless communication means wirelessly transmits a DDC/CEC radio test signal including a predetermined reference pattern to the second wireless communication apparatus as the second radio signal using the second radio channel, and receives a second estimation value relating to a second received state of the DDC/CEC radio test signal detected by the second wireless communication apparatus as the third radio signal using the second radio channel. Upon detecting that the second received state is a predetermined state based on the second estimation value, the control means controls the first wireless communication means to wirelessly transmit the TMDS radio test signal to the second wireless communication apparatus as the first radio signal using the first radio channel.

Further, in the above-mentioned wireless communication apparatus, upon detecting that the first received state substantially becomes best based on the first estimation value, the control means controls a signal source apparatus which generates the TMDS signal, the DDC downstream signal, and the CEC downstream to start communication with a signal sink apparatus which generates the DDC upstream signal and the CEC upstream signal.

The wireless communication apparatus according to the second aspect of the present invention is a second wireless communication apparatus for receiving a received signal compliant with HDMI standard, and for transmitting a transmitting signal compliant with the HDMI standard, the received signal including a TMDS signal, a DDC downstream signal, and a CEC downstream signal, the transmitted signal including a DDC upstream signal and a CEC upstream signal. The wireless communication apparatus includes third and fourth wireless communication means. The third wireless communication means receives the TMDS signal as a first radio signal using a first radio channel. The fourth wireless communication means receives a second radio signal including the DDC downstream signal and the CEC downstream signal using a second radio channel, and for wirelessly transmits the DDC upstream signal and the CEC upstream signal as a third radio signal using the second radio channel.

In the above-mentioned wireless communication apparatus, the fourth wireless communication means includes second time division multiplexing and demultiplexing means for time-division-demultiplexing the second radio signal into the DDC downstream signal and the CEC downstream signal, and for time-division-multiplexing the DDC upstream signal and the CEC upstream signal into the third radio signal.

In addition, in the above-mentioned wireless communication apparatus, the second time division multiplexing and demultiplexing means time-division-multiplexes the DDC upstream signal and the CEC upstream signal into the third radio signal with giving priority to the DDC upstream signal over the CEC upstream signal, so as to wirelessly transmit the DDC upstream signal prior to the CEC upstream signal.

Further, in the above-mentioned wireless communication apparatus, in either one of (a) a case where the DDC upstream signal includes EDID information, and (b) a case where the DDC upstream signal includes an upstream signal of HDCP authentication processing based on the HDMI standard, the second time division multiplexing and demultiplexing means time-division-multiplexes the DDC upstream signal and the CEC upstream signal into the third radio signal with giving priority to the DDC upstream signal over the CEC upstream signal, so as to wirelessly transmit the DDC upstream signal prior to the CEC upstream signal.

Still further, in the above-mentioned wireless communication apparatus, the third wireless communication means receives the first radio signal including a TMDS radio test signal including a predetermined reference pattern using the first radio channel. The second wireless communication apparatus further includes control means for detecting and outputting a first estimation value relating to a first received state of the TMDS radio test signal. The fourth wireless communication means wirelessly transmits the first estimation value as the third radio signal using the second radio channel.

In addition, in the above-mentioned wireless communication apparatus, the fourth wireless communication means receives the second radio signal including a DDC/CEC radio test signal including a predetermined reference pattern using the second radio channel. The control means detects and outputs a second estimation value relating to a second received state of the DDC/CEC radio test signal. The fourth wireless communication means wirelessly transmits the second estimation value as the third radio signal using the second radio channel.

The wireless communication apparatus according to the third aspect of the present invention is a first wireless communication apparatus for transmitting a transmitting signal compliant with HDMI standard, and for receiving a received signal compliant with the HDMI standard, the transmitting signal including a TMDS signal, a DDC downstream signal, and a CEC downstream signal, the received signal including a DDC upstream signal and a CEC upstream signal. The wireless communication apparatus includes first and second wireless communication means. The first wireless communication means for wirelessly transmits the TMDS signal, the DDC downstream signal, and the CEC downstream signal as a first radio signal using a first radio channel. The second wireless communication means receives a second radio signal including the DDC upstream signal and the CEC upstream signal using a second radio channel.

In the above-mentioned wireless communication apparatus as claimed, the TMDS signal includes a digital video signal, a digital audio signal, and auxiliary data. In addition, the first wireless communication means includes time division multiplexing and demultiplexing means for multiplexing the DDC downstream signal and the CEC downstream signal for a blanking interval of the digital video signal, so as not to overlap the DDC downstream signal and the CEC downstream signal on the digital audio signal and the auxiliary data, to time-division-multiplex the TMDS signal, the DDC downstream signal, and the CEC downstream signal into the first radio signal.

The wireless communication apparatus according to the fourth aspect of the present invention is a second wireless communication apparatus for receiving a received signal compliant with HDMI standard, and for transmitting a transmitting signal compliant with the HDMI standard, the received signal including a TMDS signal, a DDC downstream signal, and a CEC downstream signal, the transmitted signal including a DDC upstream signal and a CEC upstream signal. The wireless communication apparatus includes third and fourth wireless communication means. The third wireless communication means receives a first radio signal including the TMDS signal, the DDC downstream signal, and the CEC downstream signal using a first radio channel. The fourth wireless communication means for wirelessly transmits the DDC upstream signal and the CEC upstream signal as a second radio signal using a second radio channel.

The wireless communication system according to the fifth aspect of the present invention includes the first wireless communication apparatus according to the first aspect of the present invention and the second wireless communication apparatus according to the second aspect of the present invention.

The wireless communication system according to the sixth aspect of the present invention includes the first wireless communication apparatus according to the third aspect of the present invention and the second wireless communication apparatus according to the fourth aspect of the present invention.

### Effects of the Invention

According to the first wireless communication apparatus according to the first aspect of the present invention, the first wireless communication apparatus transmits a transmitting signal compliant with HDMI standard, and receives a received signal compliant with the HDMI standard. In this case, the transmitting signal includes a TMDS signal, a DDC downstream signal, and a CEC downstream signal. The received signal includes a DDC upstream signal and a CEC upstream signal. The first wireless communication apparatus includes first and second wireless communication means. The first wireless communication means wirelessly transmits the TMDS signal as a first radio signal using a first radio channel. The second wireless communication means wirelessly transmits the DDC downstream signal and the CEC downstream signal as a second radio signal using a second radio channel, and receives a third radio signal including the DDC upstream signal and the CEC upstream signal using the second radio channel. Accordingly, the first wireless communication apparatus can wirelessly transmit the TMDS signal, the DDC downstream signal, and the CEC downstream signal generated by the HDMI source apparatus, and wirelessly receives the DDC upstream signal and the CEC upstream signal and output the same signals to the HDMI source apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI source apparatus connected to the first wireless communication apparatus.

According to the second wireless communication apparatus according to the second aspect of the present invention, the second aspect of the present invention receives a received signal compliant with HDMI standard, and transmits a transmitting signal compliant with the HDMI standard. In this case, the received signal includes a TMDS signal, a DDC downstream signal, and a CEC downstream signal. The transmitted signal includes a DDC upstream signal and a CEC upstream signal. The second wireless communication apparatus includes third and fourth wireless communication means. The third wireless communication means receives the TMDS signal as a first radio signal using a first radio channel. The fourth wireless communication means receives a second radio signal including the DDC downstream signal and the CEC downstream signal using a second radio channel, and for wirelessly transmits the DDC upstream signal and the CEC upstream signal as a third radio signal using the second radio channel. Accordingly, the second wireless communication apparatus can wirelessly transmit the DDC upstream signal and the CEC upstream signal generated by the HDMI sink apparatus, and wirelessly receives the TMDS signal, the DDC downstream signal, and the CEC downstream signal and output the same signals to the HDMI sink apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI sink apparatus connected to the second wireless communication apparatus.

According to the first wireless communication apparatus according to the third aspect of the present invention, the first wireless communication apparatus transmits a transmitting signal compliant with HDMI standard, and receives a received signal compliant with the HDMI standard. In this case, the transmitting signal includes a TMDS signal, a DDC downstream signal, and a CEC downstream signal. The received signal includes a DDC upstream signal and a CEC upstream signal. The first wireless communication apparatus includes first and second wireless communication means. The first wireless communication means for wirelessly transmits the TMDS signal, the DDC downstream signal, and the CEC downstream signal as a first radio signal using a first radio channel. The second wireless communication means receives a second radio signal including the DDC upstream signal and the CEC upstream signal using a second radio channel. Accordingly, the first wireless communication apparatus can wirelessly transmit the TMDS signal, the DDC downstream signal, and the CEC downstream signal generated by the HDMI source apparatus, and wirelessly receives the DDC upstream signal and the CEC upstream signal and output the same signals to the HDMI source apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI source apparatus connected to the first wireless communication apparatus.

According to the second wireless communication apparatus according to the fourth aspect of the present invention, the second wireless communication apparatus receives a received signal compliant with HDMI standard, and transmits a transmitting signal compliant with the HDMI standard. In this case, the received signal includes a TMDS signal, a DDC downstream signal, and a CEC downstream signal. The transmitted signal includes a DDC upstream signal and a CEC upstream signal. The wireless communication apparatus includes third and fourth wireless communication means. The third wireless communication means receives a first radio signal including the TMDS signal, the DDC downstream signal, and the CEC downstream signal using a first radio channel. The fourth wireless communication means for wirelessly transmits the DDC upstream signal and the CEC upstream signal as a second radio signal using a second radio channel. Accordingly, the second wireless communication apparatus can wirelessly transmit the DDC upstream signal and the CEC upstream signal generated by the HDMI sink apparatus, and wirelessly receives the TMDS signal, the DDC downstream signal, and the CEC downstream signal and output the same signals to the HDMI sink apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI sink apparatus connected to the second wireless communication apparatus.

The wireless transmission system according to the fifth aspect of the invention includes the first wireless communication apparatus according to the first aspect of the invention, and the second wireless communication apparatus according to the second aspect of the invention. Accordingly, by connecting the first wireless communication apparatus to the HDMI source apparatus, and connecting the second wireless communication apparatus to the HDMI sink apparatus, it is possible to wirelessly transmit the DDC downstream signal and the CEC downstream signal generated by the HDMI source apparatus, and wirelessly transmits the DDC upstream signal, and the CEC upstream signal generated by the HDMI sink apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI source apparatus connected to the first wireless communication apparatus and the installation location of the HDMI sink apparatus connected to the second wireless communication apparatus.

The wireless transmission system according to the sixth aspect of the invention includes the first wireless communication apparatus according to the third aspect of the invention, and the second wireless communication apparatus according to the fourth aspect of the invention. Accordingly, by connecting the first wireless communication apparatus to the HDMI source apparatus, and connecting the second wireless communication apparatus to the HDMI sink apparatus, it is possible to wirelessly transmit the DDC downstream signal and the CEC downstream signal generated by the HDMI source apparatus, and wirelessly transmits the DDC upstream signal, and the CEC upstream signal generated by the HDMI sink apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI source apparatus connected to the first wireless communication apparatus and the installation location of the HDMI sink apparatus connected to the second wireless communication apparatus.

### BRIEF DESCRIPTION OF THE DRAWINGS

FIG. 1 is a block diagram showing a configuration of a wireless transmission system according to a first preferred embodiment of the present invention, including a DVD player 100, adapter apparatuses 200 and 300, and a PDP apparatus 400;

FIG. 2 is a block diagram showing configurations of the DVD player 100 and the adapter apparatus 200 shown in FIG. 1;

FIG. 3 is a block diagram showing configurations of the adapter apparatus 300 and the PDP apparatus 400 shown in FIG. 1;

FIG. 4 is a diagram showing a frequency spectrum of the wireless transmission system shown in FIG. 1;

FIG. 5 is a timing chart showing a timing of a signal transmitted using TMDS radio channels 81a or 81b shown in FIG. 4;

FIG. 6 is a timing chart showing timings of signals transmitted using a DDC/CEC radio channel 82 shown in FIG. 4;

FIG. 7 is a sequence diagram showing a first operational example of the wireless transmission system shown in FIG. 1;

FIG. 8 is a sequence diagram showing a second operational example of the wireless transmission system shown in FIG. 1;

FIG. 9 is a block diagram showing a configuration of a wireless transmission system according to a second preferred embodiment of the present invention, including the DVD player 100, adapter apparatuses 200A and 300A, and the PDP apparatus 400;

FIG. 10 is a block diagram showing configurations of the DVD player 100 and the adapter apparatus 200A shown in FIG. 9;

FIG. 11 is a block diagram showing configurations of the adapter apparatus 300A and the PDP apparatus 400 shown in FIG. 9;

FIG. 12 is a diagram showing a frequency spectrum of the wireless transmission system shown in FIG. 9;

FIG. 13 is a diagram showing a transmission format of a signal transmitted using TMDS/DDC/CEC radio channels 84a or 84b shown in FIG. 12; and

FIG. 14 is a timing chart showing timings of signals transmitted using a DDC/CEC radio upstream channel 83 shown in FIG. 12.

### DESCRIPTION OF REFERENCE SYMBOLS

20, 20A, 50,50A . . . Controller,
21, 51 . . . TMDS interface,
22, 63 . . . Modulator,
23, 64 . . . Wireless transmitter circuit,
24, 31, 54, 61 . . . Antenna,
25, 55 . . . DDC interface,
26, 56 . . . CEC interface,
27, 27A, 57, 57A . . . Time division multiplexer and demultiplexer,
28, 28A, 58, 58A . . . Buffer memory,
29, 59 . . . Modulator and demodulator,
30, 60 . . . Wireless communication circuit,
32 . . . TMDS multiplexer circuit,
33, 52 . . . Demodulator,
34, 53 . . . Wireless receiver circuit,
62 . . . TMDS separation circuit,
81a, 81b . . . TMDS radio channel,
82 . . . DDC/CEC radio channel,
100 . . . DVD player,
110 . . . Controller,
111 . . . HDCP authentication resistor,
112 . . . Decoder,
113 . . . DVD drive,
114 . . . DVD,
115 . . . Interface,
200, 200A, 300, 300A . . . Adapter apparatus,
400 . . . PDP apparatus,
410 . . . Controller,
411 . . . CPU,
412 . . . RAM,
413 . . . ROM,
414 . . . EDID memory,
415 . . . Bus,
450 . . . Interface,
451 . . . Video signal processing circuit,
452 . . . Display,
453 . . . Audio signal processing circuit,
454 . . . Loudspeaker,
501, 502 . . . HDMI cable,
501a, 502a . . . TMDS channel,
501b, 502b . . . TMDS clock channel,
501c, 502c . . . DDC channel,
501d, 502d . . . CEC line, and
501e, 502e . . . HPD line.

### BEST MODE FOR CARRYING OUT THE INVENTION

Embodiments according to the present invention will be described hereinafter with reference to the drawings. In addition, the same reference numerals are given to those similar to constitutional elements.

### FIRST PREFERRED EMBODIMENT

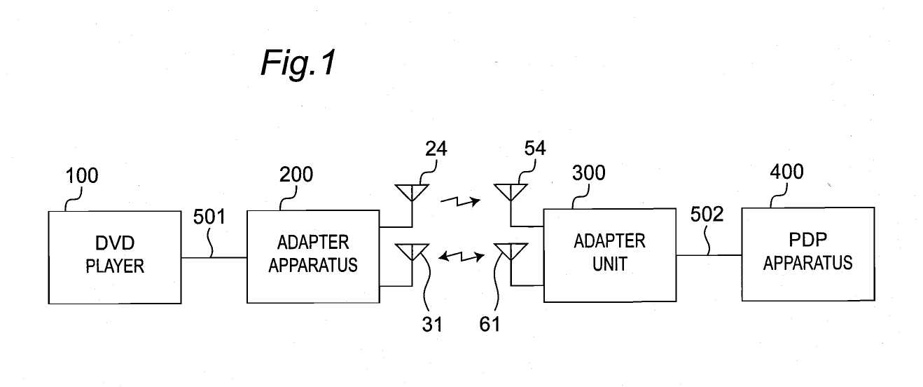

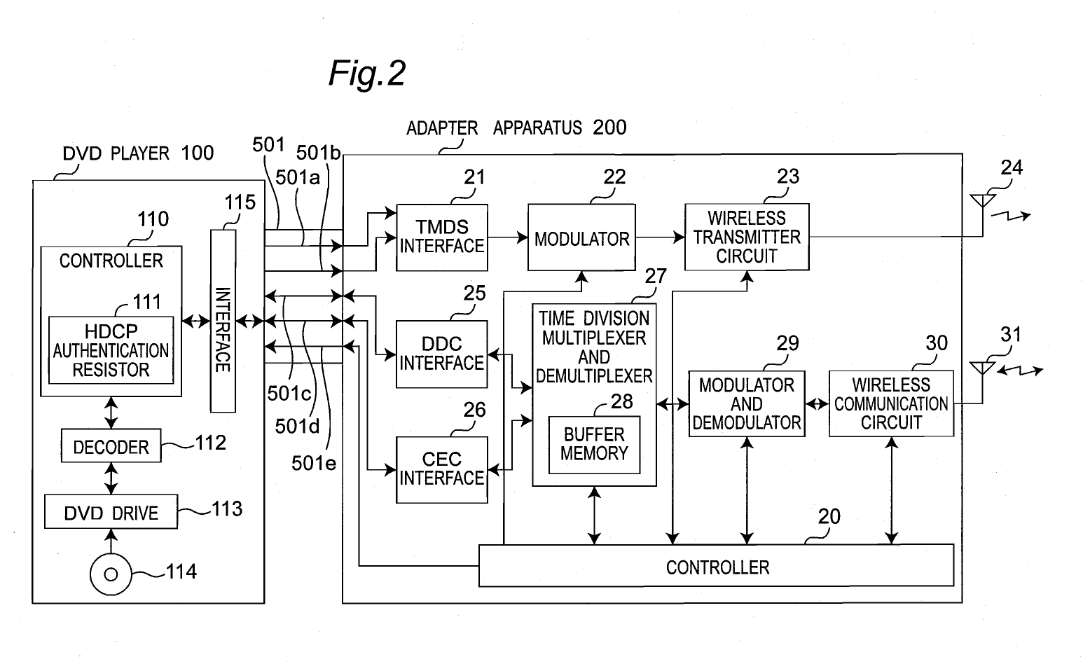

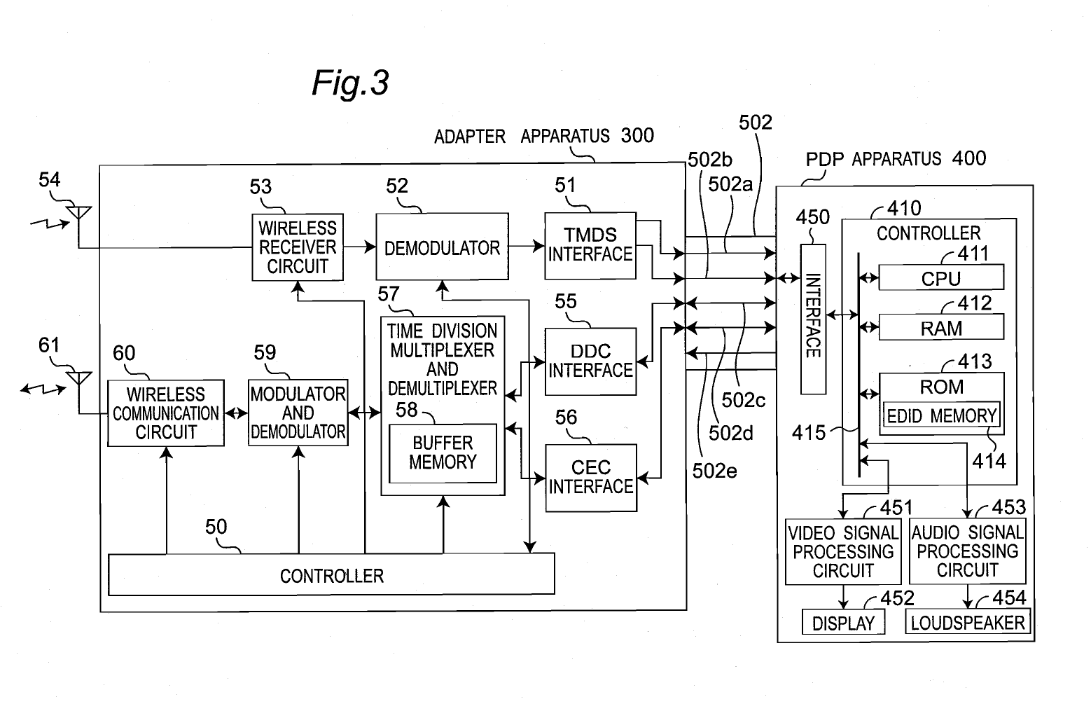

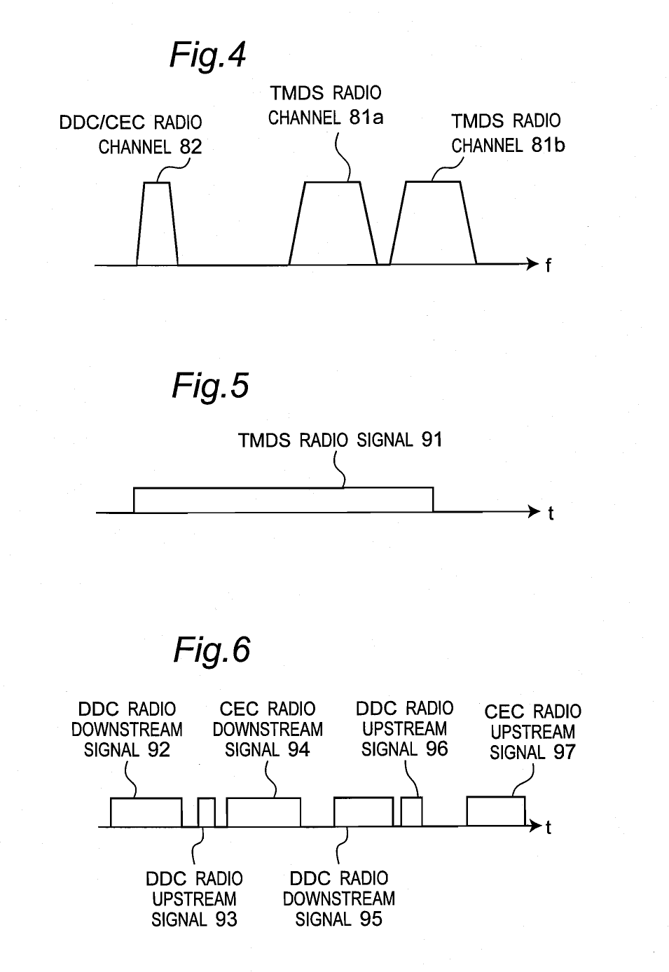

FIG. 1 is a block diagram showing a configuration of a wireless transmission system according to a first preferred embodiment of the present invention, including a DVD player 100, adapter apparatuses 200 and 300, and a PDP (Plasma Display Panel) apparatus 400. In addition, FIG. 2 is a block diagram showing configurations of the DVD player 100 and the adapter apparatus 200 shown in FIG. 1, and FIG. 3 is a block diagram showing configurations of the adapter apparatus 300 and the PDP apparatus 400 shown in FIG. 1. Further, FIG. 4 is a diagram showing a frequency spectrum of the wireless transmission system shown in FIG. 1.

Referring to FIG. 1, the DVD player 100 is an HDMI source apparatus for generating and transmitting a transmitting signal compliant with HDMI (High-Definition Multimedia Interface) standard, and for receiving a received signal compliant with the HDMI standard. In this case, the transmitting signal includes a TMDS (Transition Minimized Differential Signaling) signal, a DDC (Display Data Channel) downstream signal, and a CEC (Consumer Electronics Control) downstream signal. The receiving signal includes a DDC upstream signal and a CEC upstream signal. In addition, the DVD player 100 is connected to the adapter apparatus 200 via an HDMI cable 501 of a digital data transmission bus compliant with the HDMI standard. In addition, the adapter apparatus 200 is wirelessly connected to the adapter apparatus 300 via antennas 24 and 31 of the adapter apparatus 200 and antennas 54 and 61 of the adapter apparatus 300. As to be described in detail below, the adapter apparatus 200 wirelessly transmits the TMDS signal, the DDC downstream signal, and the CEC downstream signal outputted from the DVD player 100 to the adapter apparatus 300, and receives a radio signal including the DDC upstream signal and the CEC upstream signal transmitted from the adapter apparatus 300. Further, as to be described in detail below, the adapter apparatus 300 receives the TMDS signal, the DDC downstream signal, and the CEC downstream signal transmitted from the adapter apparatus 200, and wirelessly transmits the DDC upstream signal and the CEC upstream signal outputted from the PDP apparatus 400 to the adapter apparatus 200. Furthermore, the adapter apparatus 300 is connected to the PDP apparatus 400 via an HDMI cable 502 of a digital data transmission bus compliant with the HDMI standard. The PDP apparatus 400 is an HDMI sink apparatus for receiving a received signal compliant with the HDMI standard, and for transmitting a transmitting signal compliant with the HDMI standard. In this case, the received signal includes the TMDS signal, the DDC downstream signal, and the CEC downstream signal, and the transmitting signal includes the DDC upstream signal and the CEC upstream signal.

In this case, in this description, each of a signal transmitted from the DVD player 100 to the adapter apparatus 200, a signal transmitted from the adapter apparatus 200 to the adapter apparatus 300, and a signal transmitted from the adapter apparatus 300 to the PDP apparatus 400 is referred to as a “downstream signal,” respectively. In addition, each of a signal transmitted from the PDP apparatus 400 to the adapter apparatus 300, a signal transmitted from the adapter apparatus 300 to the adapter apparatus 200, and a signal transmitted from the adapter apparatus 200 to the DVD player 100 is referred to as a “upstream signal,” respectively.

In addition, in FIG. 1, the TMDS signal generated by the DVD player 100 is transmitted to the PDP apparatus 400 via the adapter apparatus 200, the antennas 24 and 54, and the adapter apparatus 300, as to be described in detail below, In this case, the wireless communication between the antenna 24 and the antenna 54 is hold according to a one-way system using a TMDS radio channels 81a or 81b shown in FIG. 4. In addition the DDC downstream signal and the CEC downstream signal generated by the DVD player 100 are transmitted to the PDP apparatus 400 via the adapter apparatus 200, the antennas 31 and 61, and the adapter apparatus 300, respectively, as to be described in detail below. On the other hand, the DDC upstream signal and the CEC upstream signal generated by the PDP apparatus 400 are transmitted to the DVD player 100 via the adapter apparatus 300, the antennas 61 and 31, and the adapter apparatus 200, respectively, as to be described in detail below. In this case, the wireless communication between the antenna 31 and the antenna 61 is hold according to a simplex system using a DDC/CEC radio channel 82 shown in FIG. 4. Further, the TMDS radio channels 81a and 81b and the DDC/CEC radio channel 82 are frequency-multiplexed so that the frequencies thereof are different from each other. The TMDS radio channels 81a and 81b and the DDC/CEC radio channel 82 may be time-division-multiplexed.

Referring to FIG. 2, the HDMI cable 501 includes three TMDS channels 501a, a TMDS clock channel 501b, a DDC channel 501c, a CEC line 501d, and an HPD (Hot Plug Detect) line 501e. In addition, in FIG. 3, the HDMI cable 502 includes three TMDS channels 502a, a TMDS clock channel 502b, a DDC channel 502c, a CEC line 502d, and an HPD line 502e.

Referring to FIG. 2, the DVD player 100 is constructed by including a controller 110, a decoder 112, a DVD drive 113, a DVD 114, and an interface 115. The controller 110 is a controller provided for controlling the whole operation of the DVD player 100. In this case, the controller 110 includes an HDCP (High-bandwidth Digital Content Protection) authentication resistor 111. The controller 110 writes an authentication certificate outputted from the PDP apparatus 400 in the HDCP authentication resistor 111, when the controller 110 performs HDCP authentication processing compliant with the HDMI standard for authenticating the PDP apparatus 400 via the adapter apparatuses 200 and 300.

In addition, in the DVD player 100, the interface 115 executes interface processing with the adapter apparatus 200 on a signal inputted from the controller 110 to generate a signal compliant with the HDMI standard, and outputs the same signal to the adapter apparatus 200 via the HDMI cable 501. Further, the interface 115 receives a signal inputted from the adapter apparatus 200 via the HDMI cable 501, executes predetermined interface processing including signal conversion and protocol conversion on the received signal, and outputs the same signal to the controller 110.

Further, in the DVD player 100, operation of the decoder 112 is controlled by the controller 110. The decoder 112 reproduces contents stored in the DVD 114 using the DVD drive 113 to generate video data, audio data, a horizontal synchronizing signal and a vertical synchronizing signal of a video signal, and auxiliary data, and outputs the same data and signals to the controller 110.

The controller 110 generates the TMDS signal including a digital video signal, a digital audio signal, auxiliary data, and a pixel clock signal based on the video data, the audio data, the horizontal synchronizing signal and the vertical synchronizing signal of the video signal, and the auxiliary data outputted from the decoder 112. Then, the controller 110 outputs the TMDS signal to the adapter apparatus 200 via the TMDS channel 501a of the HDMI cable 501, and outputs the pixel clock signal to the adapter apparatus 200 via the TMDS clock channel 501b of the HDMI cable 501. In addition, the controller 110 generates the DDC downstream signal including an EDID (Extended Display Identification Data) request signal for requesting the EDID for the PDP apparatus 400, and the DDC downstream signal including an initial message, pseudo random number data, a session key, and the like in the HDCP authentication processing, and outputs the same signals to the adapter apparatus 200 via the DDC channel 501c of the HDMI cable 501. In addition, the controller 110 receives the DDC upstream signal including the EDID data outputted by the PDP apparatus 400, and the DDC upstream signal including the authentication certificate or the like outputted by the PDP apparatus 400 during the HDCP authentication via the DDC channel 501c of the HDMI cable 501. Further, the controller 110 generates the CEC downstream signal including a control signal compliant with the CEC standard, and outputs the same signal to the adapter apparatus 200 via the CEC line 501d of the HDMI cable 501, and receives the CEC upstream signal including the control signal compliant with the CEC standard outputted by the PDP apparatus 400, from the adapter apparatus 200 via the CEC line 501d of the HDMI cable 501. Furthermore, upon receiving the HPD signal compliant with the HDMI standard from the adapter apparatus 200 via the HPD line 501e of the HDMI cable 501, the controller 110 executes predetermined initialization processing.

Referring to FIG. 2, the adapter apparatus 200 includes a controller 20, a TMDS interface 21, a modulator 22, a wireless transmitter circuit 23 provided with the antenna 24, a DDC interface 25, a CEC interface 26, a time division multiplexer and demultiplexer 27 provided with a buffer memory 28, a modulator and demodulator 29, and a wireless communication circuit 30 provided with the antenna 31. In this case, each of the antennas 24 and 54 is a directional antenna such as an array antenna, and each of the antennas 31 and 61 is a nondirectional antenna such as an omni antenna.

In the adapter apparatus 200, the controller 20 is provided for controlling the whole operation of the adapter apparatus 200, and each operation of the modulator 22, the wireless transmitter circuit 23, the time division multiplexer and demultiplexer 27, the modulator and demodulator 29, and the wireless communication circuit 30.

The TMDS interface 21 receives the TMDS signal inputted via the TMDS channel 501a of the HDMI cable 501, and the pixel clock signal inputted via the TMDS channel 501b of the HDMI cable 501, performs serial-to-parallel conversion of the received TMDS signal in synchronization with the received pixel clock signal to generate the digital video signal, the digital audio signal, and the auxiliary data, and outputs the same signals and data to the modulator 22. The modulator 22 multiplexes the digital video signal, the digital audio signal, and the auxiliary data outputted from the TMDS interface 21, and TMDS radio information outputted from the controller 20, which includes MAC (Media Access Control) addresses of the adapter apparatus 200 and the adapter apparatus 300, into a baseband signal. Then the modulator 22 performs baseband signal processing such as modulation processing using an OFDM (Orthogonal Frequency Division Multiplexing; referred to as OFDM hereinafter) method, for example, on the multiplexed baseband signal. Further, the modulator 22 converts the processed digital multiplexed baseband signal into an analog signal, and outputs the analog signal to the wireless transmitter circuit 23. The wireless transmitter circuit 23 performs high-frequency signal processing such as high frequency conversion and power amplification on the inputted signal, according to transmitting parameters from the controller 20, generate a TMDS radio signal based on the processed signal, and wirelessly transmits the same signal to the adapter apparatus 300 via the antenna 24. In this case, the transmitting parameters include data of the TMDS radio channel used (the TMDS radio channel 81a or 81b) and data relating to a directional pattern of the antenna 24.

The DDC interface 25 receives the DDC downstream signal inputted from the DVD player 100 via the DDC channel 501c of the HDMI cable 501, executes predetermined interface processing including signal conversion and protocol conversion on the received signal, and outputs the same signal to the time division multiplexer and demultiplexer 27. In addition, the DDC interface 25 executes the predetermined interface processing including the signal conversion and the protocol conversion on the DDC upstream signal outputted from the time division multiplexer and demultiplexer 27, and outputs the same signals to the DVD player 100 via the DDC channel 501c of the HDMI cable 501.

The CEC interface 26 receives the CEC downstream signal inputted from the DVD player 100 via the DDC channel 501d of the HDMI cable 501, executes predetermined interface processing including signal conversion and protocol conversion on the received signal, and outputs the same signal to the time division multiplexer and demultiplexer 27. In addition, the CEC interface 26 executes predetermined interface processing including signal conversion and the protocol conversion on the CEC upstream signal outputted from the time division multiplexer and demultiplexer 27, and outputs the same signal to the DVD player 100 via the CEC channel 501d of the HDMI cable 501.

The time division multiplexer and demultiplexer 27 stores the inputted DDC downstream signal and the CEC downstream signal in the buffer memory 28, and thereafter, time-division-multiplexes the stored DDC downstream signal and CEC downstream signal with providing a predetermined guard time between the respective signals, and outputs the resultant signal to the modulator and demodulator 29. In this case, in the following cases, the time division multiplexer and demultiplexer 27 time-division-multiplexes the DDC downstream signal and the CEC downstream signal into the resultant signal with giving priority to the DDC downstream signal over the CEC downstream signal, so as to output the DDC downstream signal to the modulator and demodulator 29 prior to the CEC downstream signal:
(a) When the DDC downstream signal and the CEC downstream signal are simultaneously inputted to the time division multiplexer and demultiplexer 27,
(b) When the DDC downstream signal includes the EDID request signal of a readout request signal for the EDID information, and
(c) When the DDC downstream signal includes the downstream signal of the HDCP authentication processing in which the DVD player 100 authenticates the PDP apparatus 400.

Further, the time division multiplexer and demultiplexer 27 stores a signal outputted from the modulator and demodulator 29 in the buffer memory 28, and thereafter, time-division-demultiplexes the stored signal into the DDC upstream signal and the CEC upstream signal, and outputs the generated DDC upstream signal and CEC upstream to the DDC interface 25 and the CEC interface 26, respectively.

The modulator and demodulator 29 multiplexes the signal outputted from the time division multiplexer and demultiplexer 27 and DDC/CEC radio information outputted from the controller 20 into the baseband signal, digitally modulates a radio carrier wave using a predetermined digital modulation method according to the baseband signal, and thereafter, converts the resultant digital signal into an analog signal, and outputs the analog signal to the wireless communication circuit 30. In this case, the DDC/CEC radio information includes the respective MAC addresses of the adapter apparatus 200 and the adapter apparatus 300, and identification information for distinguishing the DDC downstream signal from the CEC downstream signal. In addition, the modulator and demodulator 29 converts the analog signal outputted from the wireless communication circuit 30 into a digital signal, and thereafter, demodulates the digital signal into the baseband signal using predetermined digital demodulation method, performs separation processing for separating the DDC/CEC radio information from the baseband signal, and outputs the processed baseband signal to the time division multiplexer and demultiplexer 27.

The wireless communication circuit 30 performs high-frequency signal processing such as high frequency conversion and power amplification on the signal outputted from the modulator and demodulator 29 according to transmitting parameters from the controller 20, and wirelessly transmits the processed radio transmitting signal to the adapter apparatus 300 via the antenna 31. In this case, the transmitting parameters include data of the DDC/CEC radio channel 82 used. In addition, the wireless communication circuit 30 performs high-frequency signal processing such as low frequency conversion and power amplification on the signal received by the antenna 31, and outputs the processed signal to the modulator and demodulator 29.

Referring to FIG. 3, the adapter apparatus 300 includes a controller 50, a TMDS interface 51, a demodulator 52, a wireless receiver circuit 53 provided with and the antenna 54, a DDC interface 55, a CEC interface 56, a time division multiplexer and demultiplexer 57 provided with a buffer memory 58, a modulator and demodulator 59, and a wireless communication circuit 60 provided with the antenna 61.

In the adapter apparatus 300, the controller 50 is provided for controlling the whole operation of the adapter apparatus 300, and each operation of the demodulator 52, the wireless receiver circuit 53, the time division multiplexer and demultiplexer 57, the modulator and demodulator 59, and the wireless communication circuit 60.

The wireless receiver circuit 53 performs high-frequency signal processing such as low frequency conversion and power amplification on the TMDS radio signal received by the antenna 54 according to receiving parameters from the controller 50, and outputs the processed signal to the demodulator 52. In this case, the receiving parameters include data of the TMDS radio channels used (the TMDS radio channel 81a or 81b) and data relating to a directional pattern of the antenna 54. The demodulator 52 converts the analog signal outputted from the wireless receiver circuit 53 into a digital signal, and thereafter, demodulates the digital signal to the baseband signal using a predetermined digital demodulation method, performs separation processing for separating the TMDS radio information from the baseband digital, and outputs the processed baseband signal and the TMDS radio information to the TMDS interface 51. The TMDS interface 51 performs predetermined interface processing including signal conversion and protocol conversion on the baseband signal outputted from the demodulator 52 to generate the TMDS signal and the pixel clock signal, and outputs the same signals to the PDP apparatus 400 via the TMDS channel 501a of the HDMI cable 502 and the TMDS clock channel 501b, respectively.

The DDC interface 55 receives the DDC upstream signal inputted from the PDP apparatus 400 via the DDC channel 502c of the HDMI cable 502, executes predetermined interface processing including signal conversion and protocol conversion on the inputted DDC upstream signal, and outputs the same signal to the time division multiplexer and demultiplexer 57. In addition, the DDC interface 55 executes predetermined interface processing including the signal conversion and the protocol conversion on the DDC downstream signal outputted from the time division multiplexer and demultiplexer 57, and outputs the same signal to the PDP apparatus 400 via the DDC channel 502c of the HDMI cable 502.

The CEC interface 56 receives the CEC upstream signal inputted from the PDP apparatus 400 via the DDC channel 502d of the HDMI cable 502, executes predetermined interface processing including signal conversion and protocol conversion on the inputted CEC upstream signal, and outputs the same signal to the time division multiplexer and demultiplexer 57. In addition, the CEC interface 56 executes predetermined interface processing including the signal conversion and the protocol conversion on the CEC downstream signal outputted from the time division multiplexer and demultiplexer 57, and outputs the same signal to the PDP apparatus 400 via the CEC channel 502d of the HDMI cable 502.

The time division multiplexer and demultiplexer 57 stores the inputted DDC upstream signal and the CEC upstream signal in the buffer memory 58, and thereafter, time-division-multiplexes the stored DDC upstream signal and the CEC upstream signal with providing a predetermined guard time between the respective signals, and outputs the resultant signal to the modulator and demodulator 59. In this case, in the following cases, the time division multiplexer and demultiplexer 57 time-division-multiplexes the DDC upstream signal and the CEC upstream signal into the resultant signal with giving priority to the DDC upstream signal over the CEC upstream signal, so as to output the DDC upstream signal over the CEC upstream signal to the modulator and demodulator 59 prior to the CEC upstream signal:
(a) When the DDC upstream signal and the CEC upstream signal are simultaneously inputted to the time division multiplexer and demultiplexer 57,
(b) When the DDC upstream signal includes the EDID data, and
(c) When the DDC upstream signal includes the upstream signal of the HDCP authentication processing in which the DVD player 100 authenticates the PDP apparatus 400.

Further, the time division multiplexer and demultiplexer 57 stores a signal outputted from the modulator and demodulator 59 in the buffer memory 58, and thereafter, time-division-demultiplexes the stored signal into the DDC downstream signal and the CEC downstream signal, and outputs the generated DDC downstream signal and CEC downstream signal to the DDC interface 55 and the CEC interface 56, respectively.

The modulator and demodulator 59 multiplexes the signal outputted from the time division multiplexer and demultiplexer 57 and DDC/CEC radio information outputted from the controller 50 into the baseband signal, digitally modulates a radio carrier wave using a predetermined digital modulation method according to the baseband signal, and thereafter, converts the resultant digital signal into an analog signal, and outputs the analog signal to the wireless communication circuit 60. In this case, the DDC/CEC radio information includes the respective MAC addresses of the adapter apparatus 200 and the adapter apparatus 300, and identification information for distinguishing the DDC upstream signal from the CEC upstream signal. In addition, the modulator and demodulator 59 converts the analog signal outputted from the wireless communication circuit 60 into a digital signal, and thereafter, demodulates the digital signal into the baseband signal using predetermined digital demodulation method, performs separation processing for separating the DDC/CEC radio information from the baseband signal, and outputs the processed baseband signal to the time division multiplexer and demultiplexer 57.

The wireless communication circuit 60 performs high-frequency signal processing such as high frequency conversion and power amplification on the signal outputted from the modulator and demodulator 59 according to transmitting parameters from the controller 50, and wirelessly transmits the processed radio transmitting signal to the adapter apparatus 200 via the antenna 61. In this case, the transmitting parameters include data of the DDC/CEC radio channel 82 used. In addition, the wireless communication circuit 60 performs high-frequency signal processing such as low frequency conversion and power amplification on the signal received by the antenna 31, and outputs the processed signal to the modulator and demodulator 59.

Referring to FIG. 3, the PDP apparatus 400 includes a controller 410, an interface 450, a video signal processing circuit 451, a display 452, an audio signal processing circuit 453, and a loudspeaker 454. In this case, the controller 410, the interface 450, the video signal processing circuit 451, and the audio signal processing circuit 453 are connected with each other via a bus 415 of the controller 410.

In the PDP apparatus 400, the controller 410 is provided for controlling the whole operation of the PDP apparatus 400, and includes a CPU 411, a RAM 412, and a ROM 413, which are connected with each other via the bus 415. The CPU 411 is a computer for controlling the whole operation of the PDP apparatus 400, and for executing various software programs and the like. In addition, the ROM 413 preliminarily stores various kinds of software required for operating the PDP apparatus 400 and a program of the software executable by a computer executed by the CPU 411. The ROM 413 includes an EDID memory 414 which preliminarily stores the EDID data, that are apparatus parameters of the PDP apparatus 400, such as product information of the PDP apparatus 400, a manufacturer name, a video encoding method (for example, RGB, YC_{B}C_{R} 4:4:4 or YC_{BC}_{R} 4:2:2), resolution, field frequency, video output specifications such as the number of scanning lines, and audio output specifications such as audio output sampling. Further, the RAM 412 is made of an SRAM, a DRAM, an SDRAM, or the like, used as a working area of the CPU 411, and stores temporary data generated upon executing programs.

In the PDP apparatus 400, the interface 450 executes interface processing with the adapter apparatus 300, and outputs a signal and data compliant with the HDMI standard to the adapter apparatus 300 via the HDMI cable 502. In addition, the interface 450 receives the signal inputted from the adapter apparatus 300 via the HDMI cable 502, executes a predetermined interface processing including signal conversion and protocol conversion on the inputted signal, and outputs the same signal to the CPU 411.

In the controller 410, the CPU 411 receives the TMDS signal inputted via the TMDS channel 502a of the HDMI cable 502 and the pixel clock signal inputted via the TMDS channel 502b of the HDMI cable 502, performs serial-to-parallel conversion on the received TMDS signal in synchronization with the received pixel clock signal, to decode the received TMDS signal into the video data, the audio data, the horizontal synchronizing signal of the video signal, the vertical synchronizing signal of the video signal, and the auxiliary data. Further, the CPU 411 generates the video signal and the audio signal based on the video data, the audio data, the horizontal synchronizing signal of the video signal, the vertical synchronizing signal of the video signal, and the auxiliary data, and outputs the same signals to the video signal processing circuit 451 and the audio signal processing circuit 453, respectively. In addition, the CPU 411 receives the DDC downstream signal including the EDID request signal outputted by the PDP apparatus 400 and the DDC downstream signal including the downstream signal of the HDCP authentication processing with the PDP apparatus 400. Further, the CPU 411 generates the DDC upstream signal including the EDID data and the DDC upstream signal including the authentication certificate or the like, and outputs the same signals to the adapter apparatus 300 via the DDC channel 502c of the HDMI cable 502. Further, the CPU 411 generates the CEC upstream signal including the control signal compliant with the CEC standard, and outputs the same signal to the adapter apparatus 300 via the CEC line 502d of the HDMI cable 502. In addition, the CPU 411 receives the CEC downstream signal including the control signal compliant with the CEC standard outputted by the DVD player 100, from the adapter apparatus 300 via the CEC line 502d of the HDMI cable 502.

In addition, in the PDP apparatus 400, the video signal processing circuit 451 converts an inputted video signal into a video display signal having predetermined specifications, outputs the same signal to the display 452, and displays the same signal thereon. Further, the audio signal processing circuit 453 converts an inputted digital audio signal into an analog audio signal, amplifies the analog audio signal, and outputs the amplified analog audio signal to the loudspeaker 454.

FIG. 5 is a timing chart showing a timing of a signal transmitted using the TMDS radio channel 81a or 81b shown in FIG. 4. As shown in FIG. 5, a TMDS radio signal 91 outputted from the antenna 24 is wirelessly transmitted using the TMDS radio channel 81a or 81b.

FIG. 6 is a timing chart showing timings of signals transmitted using the DDC/CEC radio channel 82 shown in FIG. 4. Referring to FIG. 6, DDC radio downstream signals 92 and 95 are the DDC downstream signals included in the signal outputted from the antenna 31, and a CEC radio downstream signal 94 is the CEC downstream signal included in the signal outputted from the antenna 31. In addition, DDC radio upstream signals 93 and 96 are the DDC upstream signals included in the signal outputted from the antenna 61, and a CEC radio upstream signal 97 is the CEC upstream signal included in the signal outputted from the antenna 61. As shown in FIG. 6, the respective signals transmitted and received between the antenna 31 and the antenna 61 are wirelessly transmitted, in order of the DDC radio downstream signal 92, the DDC radio upstream signal 93, the CEC radio downstream signal 94, the DDC radio downstream signal 95, the DDC radio upstream signal 96, and the CEC radio upstream signal 97, with being provided with predetermined guard times between the respective adjacent two signals, using the DDC/CEC radio channel 82. Upon receiving the DDC radio downstream signal 92, the adapter apparatus 300 wirelessly transmits the DDC radio upstream signal 93 to the adapter apparatus 200 after a lapse of a predetermined guard time. In addition, after receiving the DDC radio upstream signal 93 and after a lapse of a predetermined guard time, the adapter apparatus 200 wirelessly transmits the CEC radio downstream signal 94 and the DDC radio downstream signal 95 to the adapter apparatus 300, with providing a predetermined guard time between the same signals 94 and 95. In addition, after receiving the DDC radio downstream signal 95 and after a lapse of a predetermined guard time, the adapter apparatus 300 wirelessly transmits the DDC radio upstream signal 96 and the CEC radio upstream signal 97 to the adapter apparatus 200, with providing a predetermined guard time between the same signals 96 and 97.

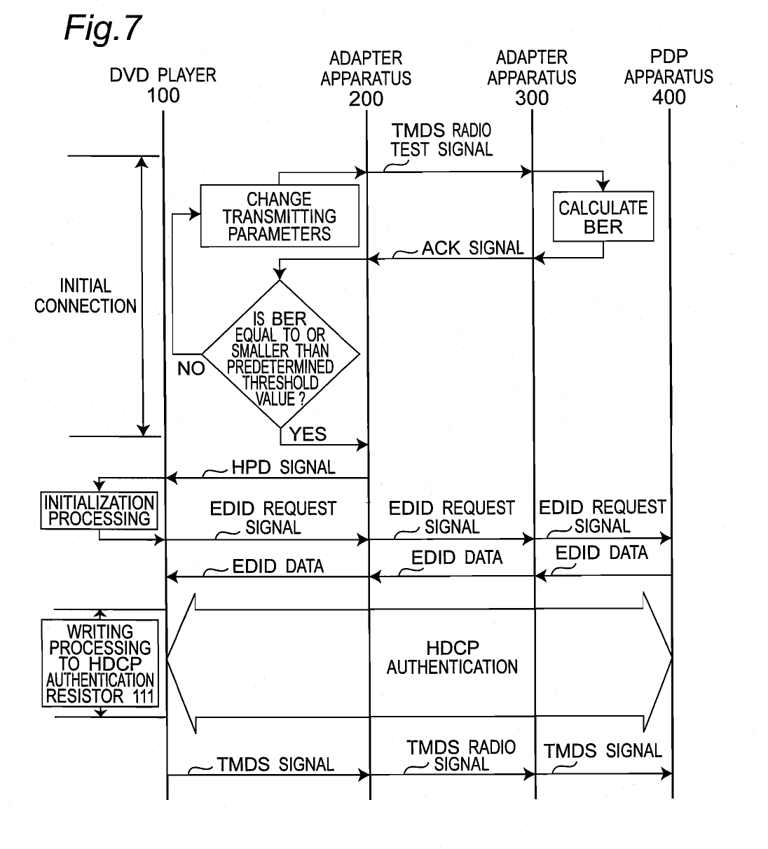

FIG. 7 is a sequence diagram showing a first operational example of the wireless transmission system shown in FIG. 1. Referring to FIG. 7, first of all, the adapter apparatus 200 and the adapter apparatus 300 make initial connection. In the initial connection, the controller 20 of the adapter apparatus 200 controls the modulator 22 to generate a TMDS radio test signal including a predetermined reference pattern and the TMDS radio information, and to output the same signal to the wireless transmitter circuit 23. Then, the wireless transmitter circuit 23 performs the high-frequency signal processing such as high frequency conversion and power amplification on the inputted TMDS radio test signal according to the transmitting parameters outputted from the controller 20, and wirelessly transmits the processed signal to the adapter apparatus 300 via the antenna 24.

The wireless receiver circuit 53 of the adapter apparatus 300 performs the high-frequency signal processing such as low frequency conversion and power amplification on the TMDS radio test signal received by the antenna 54 according to the receiving parameters outputted from the controller 50, and outputs the processed analog signal to the demodulator 52. The demodulator 52 converts the analog signal outputted from the wireless receiver circuit 53 into a digital signal, and thereafter, demodulates the digital signal to the baseband signal using the predetermined digital demodulation method, performs the separation processing for separating the TMDS radio information from the baseband digital, and outputs the processed baseband signal and the TMDS radio information to the controller 50. The controller 50 detects a BER (Bit Error Rate) based on the reference pattern included in the inputted baseband signal, generates an ACK signal including the detected BER and the TMDS radio information, and wirelessly transmits the ACK signal to the adapter apparatus 200 via the modulator and demodulator 59, the wireless communication circuit 60, and the antenna 61.

The wireless communication circuit 60 of the adapter apparatus 200 performs high-frequency signal processing such as low frequency conversion and power amplification on the ACK signal received by the antenna 31, and outputs the processed analog signal to the modulator and demodulator 29. The modulator and demodulator 29 converts the analog signal outputted from the wireless communication circuit 30 into a digital signal, and thereafter, demodulates the digital signal to the baseband signal using the predetermined digital demodulation method, and outputs the baseband signal to the controller 50. Responsive to the BER included in the inputted baseband signal, the controller 20 judges whether or not the BER is equal to or smaller than a predetermined threshold value, if NO, the controller 20 change the transmitting parameters of the TMDS radio test signal transmitted from the antenna 24, so as to make the BER smaller, and controls the modulator 22 and the wireless transmitter circuit 23 to wirelessly transmits the TMDS radio test signal according to the changed transmitting parameters. Concretely speaking, the controller 20 selects one of the TMDS radio channels 81a and 81b and changes the directional pattern of the antenna 24, so as to make the BER smaller. On the other hand, when the BER included in the inputted baseband signal is equal to or smaller than the predetermined threshold value, the controller 20 terminates the initial connection, generates the HPD signal, and outputs the HPD signal to the controller 110 of the DVD player 100 via the HPD line 501e of the HDMI cable 501. As described above, in the initial connection, the controller 20 of the adapter apparatus 200 adjusts the transmitting parameters of the TMDS radio test signal, so as to make a received state of the TMDS radio test signal at the adapter apparatus 300 substantially best.

Upon receiving the HPD signal, the controller 110 of the DVD player 100 executes the predetermined initialization processing, generates the DDC downstream signal including the EDID request signal, and outputs the same signal to the DDC interface 25 of the adapter apparatus 200. The DDC downstream signal inputted to the DDC interface 25 is wirelessly transmitted to the adapter apparatus 300 via the time division multiplexer and demultiplexer 27, the modulator and demodulator 29, the wireless communication circuit 30, and the antenna 31 as the DDC radio downstream signal including the EDID request signal, and thereafter, outputted to the CPU 411 of the PDP apparatus 400 via the wireless communication circuit 60 of the adapter apparatus 300, the modulator and demodulator 59, the time division multiplexer and demultiplexer 57, and the DDC interface 55. In response to this, the CPU 411 of the PDP apparatus 400 reads out the EDID data from the EDID memory 414, generates the DDC upstream signal including the read out EDID data, and outputs the same signal to the DDC interface 55 of the adapter apparatus 300. The DDC upstream signal inputted to the DDC interface 55 is wirelessly transmitted as the DDC radio upstream signal including the EDID data to the adapter apparatus 200 via the time division multiplexer and demultiplexer 57, the modulator and demodulator 59, the wireless communication circuit 60, and the antenna 61, and thereafter, outputted to the controller 110 of the DVD player 100 via the wireless communication circuit 30 of the adapter apparatus 200, the modulator and demodulator 39, the time division multiplexer and demultiplexer 27, and the DDC interface 25.

Then, the controller 110 of the DVD player 100 and the CPU 411 of the PDP apparatus 400 perform the HDCP authentication processing via the adapter apparatuses 300 and 200. During the HDCP authentication processing, the controller 110 of the DVD player 100 writes the authentication certificate outputted from the PDP apparatus 400 to the HDCP authentication resistor 111. After the termination of the HDCP authentication processing, the controller 110 of the DVD player 100 generates the TMDS radio signal, and outputs the same signal to the CPU 411 of the PDP apparatus 400 via the adapter apparatuses 200 and 300. It is noted that, when the copyright protection of the contents stored in the DVD 114 is not required, the HDCP authentication processing between the controller 110 of the DVD player 100 and the CPU 411 of the PDP apparatus 400 may not be performed.

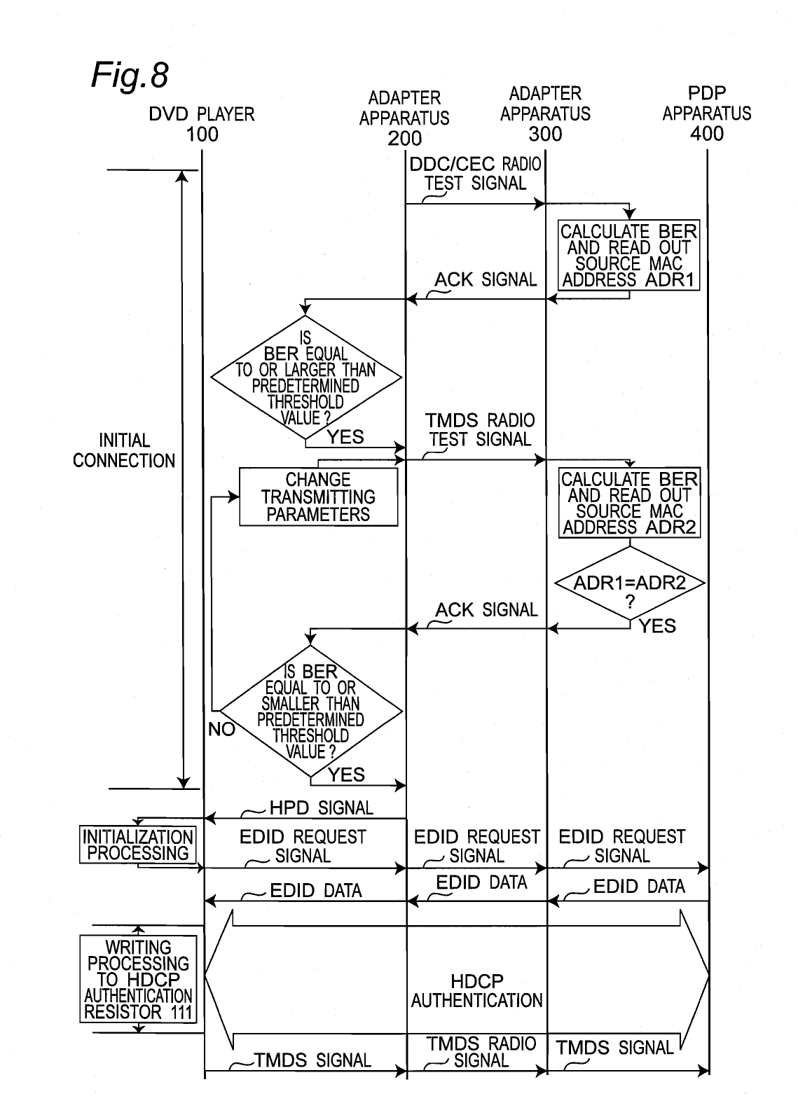

FIG. 8 is a sequence diagram showing a second operational example of the wireless transmission system shown in FIG. 1. The second operational example is different from the first operational example shown in FIG. 7 only in the initial connection between the adapter apparatus 200 and the adapter apparatus 300. In the initial connection shown in FIG. 8, the controller 20 of the adapter apparatus 200 controls the modulator and demodulator 29 to generate a DDC/CEC radio test signal including a predetermined reference pattern and the DDC/CEC radio information and to output the same signal to the wireless communication circuit 30. Then, the wireless communication circuit 30 performs the high-frequency signal processing such as high frequency conversion and power amplification on the inputted DDC/CEC radio test signal according to the transmitting parameters outputted from the controller 20, and wirelessly transmits the processed signal to the adapter apparatus 300 via the antenna 31.

The wireless communication circuit 60 of the adapter apparatus 300 performs high-frequency signal processing such as low frequency conversion and power amplification on the DDC/CEC radio test signal received by the antenna 61 according to the receiving parameters outputted from the controller 50, and outputs the processed analog signal to the modulator and demodulator 59. The modulator and demodulator 59 converts the analog signal outputted from the wireless communication circuit 60 into a digital signal, and thereafter, demodulates the digital signal to the baseband signal using the predetermined digital demodulation method, performs the separation processing for separating the DDC/CEC radio information from the baseband digital, and outputs the processed baseband signal and the DDC/CEC radio information to the controller 50. The controller 50 detects a BER based on the reference pattern included in the inputted baseband signal, and reads out a source MAC address ADR1 from the DDC/CEC radio information. Furthermore, the controller 50 generates an ACK signal including the detected BER and the DDC/CEC radio information, and wirelessly transmits the same signal to the adapter apparatus 200 via the modulator and demodulator 59, the wireless communication circuit 60, and the antenna 61.

The wireless communication circuit 30 of the adapter apparatus 200 performs high-frequency signal processing such as low frequency conversion and power amplification on the ACK signal received by the antenna 31, and outputs the processed analog signal to the modulator and demodulator 29. The modulator and demodulator 29 converts the analog signal outputted from the wireless communication circuit 30 into a digital signal, and thereafter, demodulates the digital signal to the baseband signal using the predetermined digital demodulation method, and outputs the baseband signal to the controller 20. Responsive to the BER included in the inputted baseband signal, the controller 20 judges whether or not the BER is equal to or smaller than a predetermined threshold value. Only when the BER is equal to or smaller than the predetermined threshold value, the controller 20 controls the modulator 22 to generate the TMDS radio test signal including the predetermined reference pattern and the TMDS radio information, and to output the same signal to the wireless transmitter circuit 23. Then, the wireless transmitter circuit 23 performs the high-frequency signal processing such as high frequency conversion and power amplification on the inputted TMDS radio test signal according to the transmitting parameters outputted from the controller 20, and wirelessly transmits the processed signal to the adapter apparatus 300 via the antenna 24.

The wireless receiver circuit 53 of the adapter apparatus 300 performs the high-frequency signal processing such as low frequency conversion and power amplification on the TMDS radio test signal received by the antenna 54 according to the receiving parameters outputted from the controller 50, and outputs the processed analog signal to the demodulator 52. The demodulator 52 converts the analog signal outputted from the wireless receiver circuit 53 into a digital signal, and thereafter, demodulates the digital signal to the baseband signal using the predetermined digital demodulation method, performs the separation processing for separating the TMDS radio information from the baseband digital, and outputs the processed baseband signal and the TMDS radio information to the controller 50. The controller 50 calculates a BER based on the reference pattern included in the inputted baseband signal, and reads out a source MAC address ADR2 from the TMDS radio information. Further, the controller 50 judges whether or not the source MAC address ADR1 read out from the DDC/CEC radio information coincides with the source MAC address ADR2 read out from the TMDS radio information. Only when the source MAC addresses ADR1 and ADR2 are the same as each other, the controller 50 generates an ACK signal including the calculated BER and the TMDS radio information, and wirelessly transmits the ACK signal to the adapter apparatus 200 via the modulator and demodulator 59, the wireless communication circuit 60, and the antenna 61.

The wireless communication circuit 30 of the adapter apparatus 200 performs high-frequency signal processing such as low frequency conversion and power amplification on the ACK signal received by the antenna 31, and outputs the processed analog signal to the modulator and demodulator 29. The modulator and demodulator 29 converts the analog signal outputted from the wireless communication circuit 30 into a digital signal, and thereafter, demodulates the digital signal to the baseband signal using the predetermined digital demodulation method, and outputs the baseband signal to the controller 20. Responsive to the BER included in the inputted baseband signal, the controller 20 judges whether or not the BER is equal to or smaller than a predetermined threshold value, if NO, the controller 20 change the transmitting parameters of the TMDS radio test signal transmitted from the antenna 24, so as to make the BER smaller, and controls the modulator 22 and the wireless transmitter circuit 23 to wirelessly transmits the TMDS radio test signal according to the changed transmitting parameters. Concretely speaking, the controller 20 selects one of the TMDS radio channels 81a and 81b and changes the directional pattern of the antenna 24, so as to make the BER smaller. On the other hand, when the BER included in the inputted baseband signal is equal to or smaller than the predetermined threshold value, the controller 20 terminates the initial connection, generates the HPD signal, and outputs the HPD signal to the controller 110 of the DVD player 100 via the HPD line 501e of the HDMI cable 501. As described above, in the initial connection, the controller 20 of the adapter apparatus 200 adjusts the transmitting parameters of the TMDS radio test signal, so as to make a received state of the TMDS radio test signal at the adapter apparatus 300 substantially best. The subsequent sequence is the same as the sequence shown in FIG. 7, and the description thereof will be omitted.

As described above, according to the present preferred embodiment, the adapter apparatus 200 can wirelessly transmit the TMDS signal, the DDC downstream signal, and the CEC downstream signal outputted from the DVD player 100 to the adapter apparatus 300. In addition, the adapter apparatus 200 can wirelessly receive the DDC upstream signal and the CEC upstream signal outputted from the adapter apparatus 300. On the other hand, the adapter apparatus 300 can wirelessly transmit the DDC upstream signal and the CEC upstream signal outputted from the PDP apparatus 400 to the adapter apparatus 200. In addition, the adapter apparatus 300 can wirelessly receive the TMDS signal, the DDC downstream signal, and the CEC downstream signal outputted from the adapter apparatus 200. Accordingly, the TMDS signal, the DDC downstream signal, and the CEC downstream signal generated by the DVD player 100 can be wirelessly transmitted to the PDP apparatus 400 via the adapter apparatuses 200 and 300, and the DDC upstream signal and the CEC upstream signal generated by the PDP apparatus 400 can be wirelessly transmitted to the DVD player 100 via the adapter apparatuses 300 and 200. Namely, by connecting the DVD player 100 and the PDP apparatus 400 to each other via a wireless transmission path, the connection can be realized without using any HDMI cable and simplified as compared with the prior arts. This leads to enhanced flexibility of the installation location of the DVD player 100 connected to the adapter apparatus 200 and the installation location of the PDP apparatus 400 connected to the adapter apparatus 400.

### SECOND PREFERRED EMBODIMENT

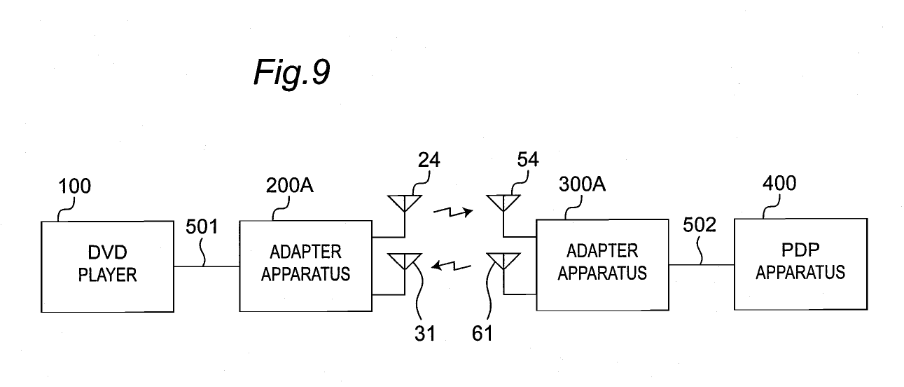

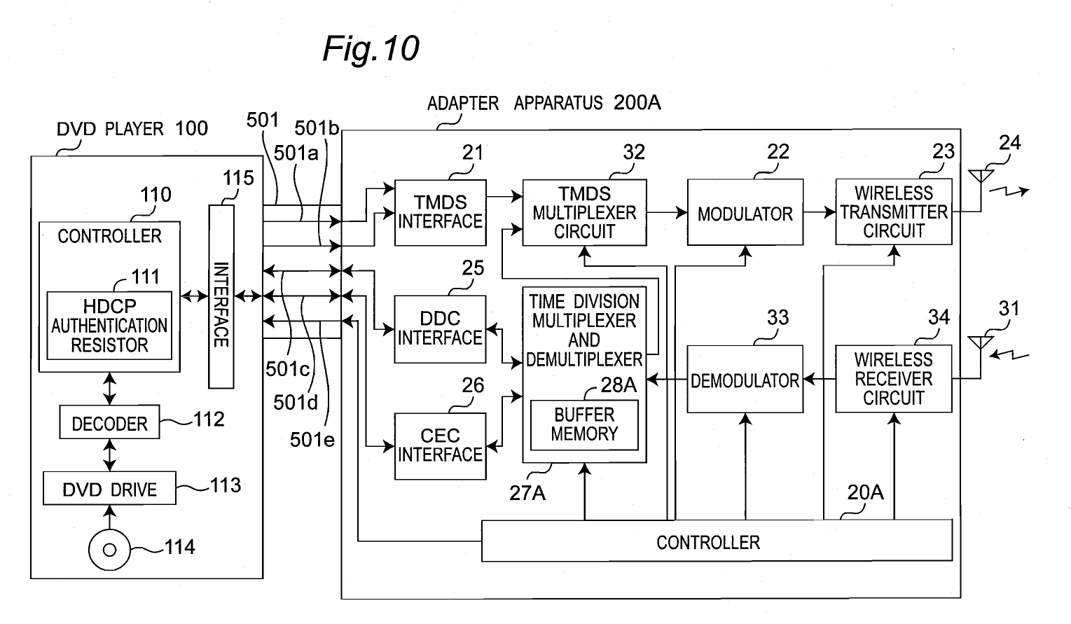

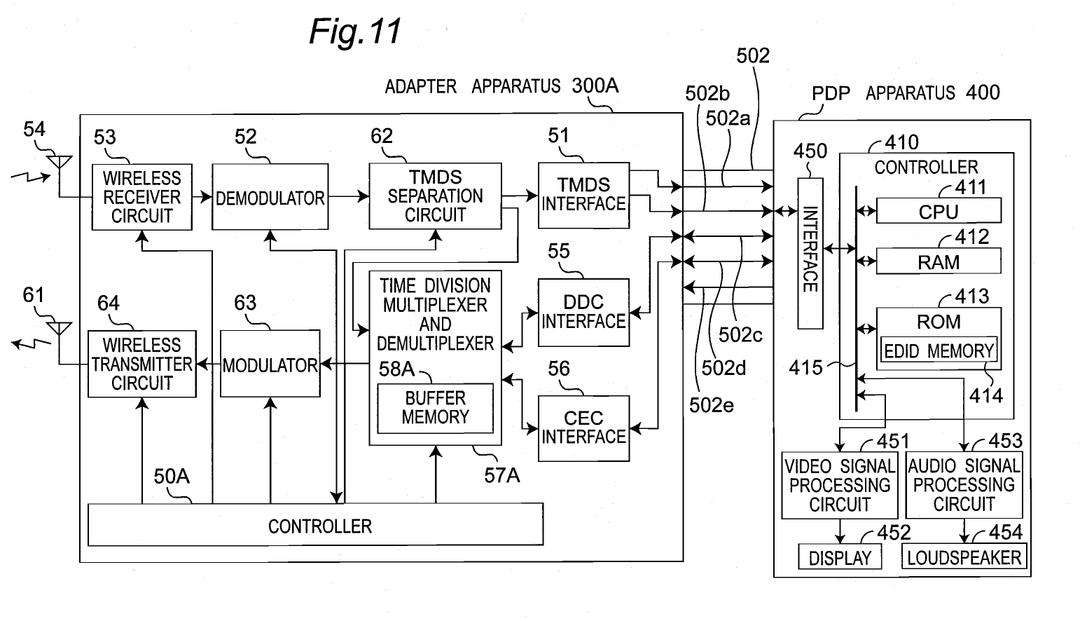

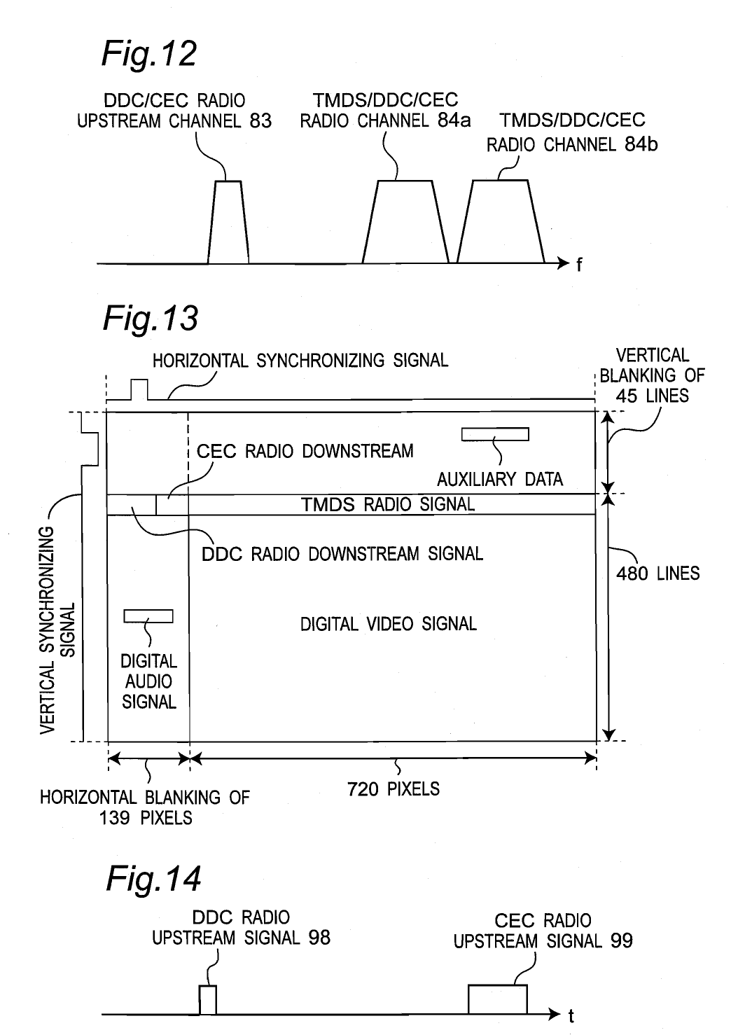

FIG. 9 is a block diagram showing a configuration of a wireless transmission system according to a second preferred embodiment of the present invention, including the DVD player 100, adapter apparatuses 200A and 300A, and the PDP apparatus 400. In addition, FIG. 10 is a block diagram showing configurations of the DVD player 100 and the adapter apparatus 200A shown in FIG. 9, and FIG. 11 is a block diagram showing configurations of the adapter apparatus 300A and the PDP apparatus 400 shown in FIG. 9. Further, FIG. 12 is a diagram showing a frequency spectrum of the wireless transmission system shown in FIG. 9. As compared with the wireless transmission system according to the first preferred embodiment, the wireless transmission system according to the second preferred embodiment is characterized in that the TMDS signal, the DDC downstream signal, and the CEC downstream signal and the DDC upstream signal and the CEC upstream signal are wirelessly transmitted between the adapter apparatus 200A and the adapter apparatus 300A using radio channels different from each other. Differences between the first and second preferred embodiments will be described in detail later.

Referring to FIG. 9, the DVD player 100 is connected to the adapter apparatus 200A via the HDMI cable 501. In addition, the adapter apparatus 200A and the adapter apparatus 300A are wirelessly connected with each other via antennas 24 and 31 of the adapter apparatus 200A and antennas 54 and 61 of the adapter apparatus 300A. Further, the adapter apparatus 300A is connected to the PDP apparatus 400.

In addition, in FIG. 9, the TMDS signal, the DDC downstream signal, and the CEC downstream signal generated by the DVD player 100 are transmitted to the PDP apparatus 400 via the adapter apparatus 200A, the antennas 24 and 54, and the adapter apparatus 300A, as to be described in detail below. In this case, wireless communication between the antenna 24 and the antenna 54 is hold according to the one-way system using a TMDS/DDC/CEC radio channel 84a or 84b shown in FIG. 12. In addition, the DDC upstream signal and the CEC upstream signal generated by the PDP apparatus 400 are transmitted to the DVD player 100 via the adapter apparatus 300A, the antennas 61 and 31, and the adapter apparatus 200A, respectively. In this case, wireless communication between the antenna 31 and the antenna 61 is hold according to the one-way system using a DDC/CEC radio upstream channel 83 shown in FIG. 12. Further, the DDC/CEC radio upstream channel 83 and the TMDS/DDC/CEC radio channels 84a and 84b are frequency-multiplexed so that the frequencies thereof are different from each other. The DDC/CEC radio upstream channel 83 and the TMDS/DDC/CEC radio channels 84a and 84b may be time-division-multiplexed.

Referring to FIG. 10, the adapter apparatus 200A includes a controller 20A, the TMDS interface 21, a TMDS multiplexer circuit 32, the modulator 22, the wireless transmitter circuit 23 provided with the antenna 24, the DDC interface 25, the CEC interface 26, a time division multiplexer and demultiplexer 27A provided with a buffer memory 28A, a demodulator 33, and a wireless receiver circuit 34 provided with the antenna 31.

In the adapter apparatus 200A, the controller 20A is provided for controlling the whole operation of the adapter apparatus 200A, and each operation of the TMDS multiplexer circuit 32, the modulator 22, the wireless transmitter circuit 23, the time division multiplexer and demultiplexer 27A, the demodulator 33, and the wireless receiver circuit 34.

The TMDS interface 21 receives the TMDS signal inputted via the TMDS channel 501a of the HDMI cable 501, and the pixel clock signal inputted via the TMDS channel 501b of the HDMI cable 501, performs serial-to-parallel conversion of the received TMDS signal in synchronization with the received pixel clock signal to generate the digital video signal, the digital audio signal, and the auxiliary data, and outputs the same signals to the TMDS multiplexer circuit 32.

In addition, the time division multiplexer and demultiplexer 27A stores the DDC downstream signal outputted from the DDC interface 25 and the CEC downstream signal from the CEC interface 26 in the buffer memory 28A, and thereafter, time-division-multiplexes the stored DDC downstream signal and CEC downstream signal, and outputs the resultant signal to the TMDS multiplexer circuit 32. In this case, in the following cases, the time division multiplexer and demultiplexer 27A time-division-multiplexes the DDC downstream signal and the CEC downstream signal into the resultant signal with giving priority to the DDC downstream signal over the CEC downstream signal, so as to output the DDC downstream signal to the TMDS multiplexer circuit 32 prior to the CEC downstream signal:
(a) When the DDC downstream signal and the CEC downstream signal are simultaneously inputted to the time division multiplexer and demultiplexer 27A,
(b) When the DDC downstream signal includes the EDID request signal of the readout request signal for the EDID information, and
(c) When the DDC downstream signal includes the downstream signal of the HDCP authentication processing in which the DVD player 100 authenticates the PDP apparatus 400.

The TMDS multiplexer circuit 32 time-division-multiplexes the signal including the DDC downstream signal and the CEC downstream signal outputted from the time division multiplex circuit 27A for a blanking interval of the digital video signal outputted from the TMDS interface 21, so as not to overlap the DDC downstream signal and the CEC downstream signal on the digital audio signal and the auxiliary data, to time-division-multiplex the TMDS signal, the DDC downstream signal, and the CEC downstream signal into a resultant signal, and thereafter, outputs the resultant signal to the modulator 22. The signal outputted to the modulator 22 is wirelessly transmitted to the adapter apparatus 300 via the wireless transmitter circuit 23 and the antenna 24 using the TMDS/DDC/CEC radio channel 84a or 84b shown in FIG. 12, in a manner similar to that of the first preferred embodiment. FIG. 13 is a diagram showing a transmission format of the signal transmitted using the TMDS/DDC/CEC radio channel 84a or 84b shown in FIG. 12. Referring to FIG. 13, a DDC radio downstream signal, a CEC radio downstream signal, and a TMDS radio signal are the DDC downstream signal, the CEC downstream signal, and the TMDS signal included in the signals outputted from the antenna 24 respectively. As shown in FIG. 13, the DDC radio downstream signal and the CEC radio downstream signal are time-division-multiplexed for the free area of the blanking interval of the digital video signal, so that the DDC radio downstream signal and the CEC radio downstream signal do not overlap with the digital audio signal and the auxiliary data.

The wireless receiver circuit 34 performs high-frequency signal processing such as low frequency conversion and power amplification on the signal received by antenna 31 according to the receiving parameters outputted from the controller 20A, and outputs the processed analog signal to the demodulator 33. In this case, the receiving parameters include data of the DDC/CEC radio upstream channel 83 used. The demodulator 33 converts the analog signal from the wireless receiver circuit 34 into a digital signal, and thereafter, demodulates the digital signal to a baseband signal using predetermined digital demodulation method, performs separation processing for separating the DDC/CEC radio information from the baseband signal, and outputs the processed baseband signal to the time division multiplexer and demultiplexer 27A. Further, the time division multiplexer and demultiplexer 27A stores the signal outputted from the demodulator 33 in the buffer memory 28A, and thereafter, time-division-demultiplexes the stored signal into the DDC upstream signal and the CEC upstream signal, and outputs the DDC upstream signal and the CEC upstream signal to the DDC interface 25 and the CEC interface 26, respectively.

Referring to FIG. 11, the adapter apparatus 300A includes a controller 50A, the TMDS interface 51, a TMDS separation circuit 62, the demodulator 52, the wireless receiver circuit 53 provided with the antenna 54, the DDC interface 55, the CEC interface 56, a time division multiplexer and demultiplexer 57A provided with a buffer memory 58A, a modulator 63, and a wireless transmitter circuit 64 provided with the antenna 61.

In the adapter apparatus 300A, the controller 50A is a controller for controlling the whole operation of the adapter apparatus 300A and each operation of the TMDS separation circuit 62, the demodulator 52, the wireless receiver circuit 53, the time division multiplexer and demultiplexer 57A, the modulator 63, and the wireless transmitter circuit 64.

The TMDS separation circuit 62 separates the digital video signal, the digital audio signal, the auxiliary data, and a signal including the DDC downstream signal and the CEC downstream signal, from the baseband signal inputted from the demodulator 52. Then, the TMDS separation circuit 62 outputs the digital video signal, the digital audio signal, and the auxiliary data to the TMDS interface 51, and outputs the signal including the DDC downstream signal and the CEC downstream signal to the time division multiplexer and demultiplexer 57A. The TMDS interface 51 executes the predetermined interface processing including signal conversion and protocol conversion on the signals outputted from the TMDS separation circuit 62 to generate the TMDS signal and the pixel clock signal, and outputs the same signals to the PDP apparatus 400 via the TMDS channel 501a and the TMDS clock channel 501b of the HDMI cable 502, respectively.

The time division multiplexer and demultiplexer 57A stores the signal outputted from the TMDS separation circuit 62 in the buffer memory 58A, and thereafter, time-division-demultiplexes the stored signal into the DDC downstream signal and the CEC downstream signal, and outputs the DDC downstream signal and the CEC downstream signal to the DDC interface 55 and the CEC interface 56, respectively.

In addition, the time division multiplexer and demultiplexer 57A stores the DDC upstream signal outputted from the DDC interface 55 and the CEC upstream signal outputted from the CEC interface 56 in the buffer memory 58A, and thereafter, time-division-multiplexes the stored DDC upstream signal and the CEC upstream signal with providing a predetermined guard time between the respective signals, and outputs the resultant signal to the modulator and demodulator 63. In this case, in the following cases, the time division multiplexer and demultiplexer 57A time-division-multiplexes the DDC upstream signal and the CEC upstream signal into the resultant signal with giving priority to the DDC upstream signal over the CEC upstream signal, so as to output the DDC upstream signal over the CEC upstream signal to the modulator 63 prior to the CEC upstream signal:
(a) When the DDC upstream signal and the CEC upstream signal are simultaneously inputted to the time division multiplexer and demultiplexer 57A,
(b) When the DDC upstream signal includes the EDID data, and
(c) When the DDC upstream signal includes the upstream signal of the HDCP authentication processing in which the DVD player 100 authenticates the PDP apparatus 400.

The modulator 63 multiplexes the signal outputted from the time division multiplexer and demultiplexer 57A and DDC/CEC radio information outputted from the controller 50A into the baseband signal, digitally modulates a radio carrier wave using a predetermined digital modulation method according to the baseband signal, and thereafter, converts the resultant signal into an analog signal, and outputs the analog signal to the wireless transmitter circuit 64. In this case, the DDC/CEC radio information includes the respective MAC addresses of the adapter apparatus 200A and the adapter apparatus 300A, and identification information for distinguishing the DDC upstream signal from the CEC upstream signal.

The wireless transmitter circuit 64 performs high-frequency signal processing such as high frequency conversion and power amplification on the signal outputted from the modulator 63 according to the transmitting parameters from the controller 50A, and wirelessly transmits the processed radio transmitting signal to the adapter apparatus 300A via the antenna 61. In this case, the transmitting parameters include data of the DDC/CEC radio upstream channel 83 used.

FIG. 14 is a timing chart showing timings of the signals transmitted using the DDC/CEC radio upstream channel 83 shown in FIG. 12. Referring to FIG. 14, the DDC radio upstream signal 98 and the CEC radio upstream signal 99 are the DDC upstream signal and the CEC upstream signal included in the signal outputted from the antenna 61, respectively. As shown in FIG. 14, the adapter apparatus 300A wirelessly transmits the DDC upstream signal 98 and the CEC radio upstream signal 99 to the adapter apparatus 200A with providing a predetermined guard time between the DDC upstream signal 98 and the CEC radio upstream signal 99.

The wireless transmission system according to the second preferred embodiment operates in a manner similar to that of the operation example shown in FIG. 8. In this case, the respective downstream signals are transmitted from the adapter apparatus 200A to the adapter apparatus 300A via the antennas 24 and 54, and the respective upstream signals are transmitted from the adapter apparatus 300A to the adapter apparatus 200A via the antennas 61 and 31.

The wireless transmission system according to the second preferred embodiment has advantages similar to those of the wireless transmission system according to the first preferred embodiment. In addition, the TMDS signal, the DDC downstream signal, and the CEC downstream signal are wirelessly transmitted using the TMDS/DDC/CEC radio channel 84a or 84b, and the DDC upstream signal and the CEC upstream signal are wirelessly transmitted using the DDC/CEC radio upstream channel 83. Accordingly, the wireless transmission system according to the second preferred embodiment can wirelessly transmit only the DDC upstream signal and the CEC upstream signal using the DDC/CEC radio channel 82 according to the first preferred embodiment, with larger transmission capacity. Further, the adapter apparatus 200A multiplexes the DDC downstream signal and the CEC downstream signal for the blanking interval of the digital video signal, so as not to overlap the DDC downstream signal and the CEC downstream signal on the digital audio signal and the auxiliary data, to time-division-multiplex the TMDS signal, the DDC downstream signal, and the CEC downstream signal into a resultant signal. Accordingly, the adapter apparatus 200A can transmit the DDC downstream signal and the CEC downstream signal by inserting the same signals into the TMDS/DDC/CEC radio channel 84a or 84b having the same transmission capacity as that of the TMDS radio channel 81a or 81b.

In the above respective preferred embodiments, different antennas 24 and 31 are used, however, the present invention is not limited to this. The antenna 24 and the antenna 31 may share one antenna. In addition, in the above respective preferred embodiments, different antennas 54 and 61 are used, however, the present invention is not limited to this. The antenna 54 and the antenna 61 may share one antenna.

Further, in the above respective preferred embodiments, the controllers 20 and 20A judge the received state of the TMDS radio test signal and the DDC/CEC radio test signal at the adapter apparatus 300 or 300A based on the BER at the time when the TMDS radio test signal and the DDC/CEC radio test signal are received by the adapter apparatus 300 or 300A, however, the present invention is not limited to this. The controllers 20 and 20A may use a signal to noise ratio (referred to as S/N) at the time when the TMDS radio test signal and the DDC/CEC radio test signal are received by the adapter apparatus 300 or 300A. Further, in the above respective preferred embodiments, the 5V signal line and the ground line included in each of the HDMI cables 501 and 502 are omitted

### INDUSTRIAL APPLICABILITY

As described so far in detail, according to the first wireless communication apparatus according to the first aspect of the present invention, the first wireless communication apparatus transmits a transmitting signal compliant with HDMI standard, and receives a received signal compliant with the HDMI standard. In this case, the transmitting signal includes a TMDS signal, a DDC downstream signal, and a CEC downstream signal. The received signal includes a DDC upstream signal and a CEC upstream signal. The first wireless communication apparatus includes first and second wireless communication means. The first wireless communication means wirelessly transmits the TMDS signal as a first radio signal using a first radio channel. The second wireless communication means wirelessly transmits the DDC downstream signal and the CEC downstream signal as a second radio signal using a second radio channel, and receives a third radio signal including the DDC upstream signal and the CEC upstream signal using the second radio channel. Accordingly, the first wireless communication apparatus can wirelessly transmit the TMDS signal, the DDC downstream signal, and the CEC downstream signal generated by the HDMI source apparatus, and wirelessly receives the DDC upstream signal and the CEC upstream signal and output the same signals to the HDMI source apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI source apparatus connected to the first wireless communication apparatus.

According to the second wireless communication apparatus according to the second aspect of the present invention, the second aspect of the present invention receives a received signal compliant with HDMI standard, and transmits a transmitting signal compliant with the HDMI standard. In this case, the received signal includes a TMDS signal, a DDC downstream signal, and a CEC downstream signal. The transmitted signal includes a DDC upstream signal and a CEC upstream signal. The second wireless communication apparatus includes third and fourth wireless communication means. The third wireless communication means receives the TMDS signal as a first radio signal using a first radio channel. The fourth wireless communication means receives a second radio signal including the DDC downstream signal and the CEC downstream signal using a second radio channel, and for wirelessly transmits the DDC upstream signal and the CEC upstream signal as a third radio signal using the second radio channel. Accordingly, the second wireless communication apparatus can wirelessly transmit the DDC upstream signal and the CEC upstream signal generated by the HDMI sink apparatus, and wirelessly receives the TMDS signal, the DDC downstream signal, and the CEC downstream signal and output the same signals to the HDMI sink apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI sink apparatus connected to the second wireless communication apparatus.

According to the first wireless communication apparatus according to the third aspect of the present invention, the first wireless communication apparatus transmits a transmitting signal compliant with HDMI standard, and receives a received signal compliant with the HDMI standard. In this case, the transmitting signal includes a TMDS signal, a DDC downstream signal, and a CEC downstream signal. The received signal includes a DDC upstream signal and a CEC upstream signal. The first wireless communication apparatus includes first and second wireless communication means. The first wireless communication means for wirelessly transmits the TMDS signal, the DDC downstream signal, and the CEC downstream signal as a first radio signal using a first radio channel. The second wireless communication means receives a second radio signal including the DDC upstream signal and the CEC upstream signal using a second radio channel. Accordingly, the first wireless communication apparatus can wirelessly transmit the TMDS signal, the DDC downstream signal, and the CEC downstream signal generated by the HDMI source apparatus, and wirelessly receives the DDC upstream signal and the CEC upstream signal and output the same signals to the HDMI source apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI source apparatus connected to the first wireless communication apparatus.

According to the second wireless communication apparatus according to the fourth aspect of the present invention, the second wireless communication apparatus receives a received signal compliant with HDMI standard, and transmits a transmitting signal compliant with the HDMI standard. In this case, the received signal includes a TMDS signal, a DDC downstream signal, and a CEC downstream signal. The transmitted signal includes a DDC upstream signal and a CEC upstream signal. The wireless communication apparatus includes third and fourth wireless communication means. The third wireless communication means receives a first radio signal including the TMDS signal, the DDC downstream signal, and the CEC downstream signal using a first radio channel. The fourth wireless communication means for wirelessly transmits the DDC upstream signal and the CEC upstream signal as a second radio signal using a second radio channel. Accordingly, the second wireless communication apparatus can wirelessly transmit the DDC upstream signal and the CEC upstream signal generated by the HDMI sink apparatus, and wirelessly receives the TMDS signal, the DDC downstream signal, and the CEC downstream signal and output the same signals to the HDMI sink apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI sink apparatus connected to the second wireless communication apparatus.

The wireless transmission system according to the fifth aspect of the invention includes the first wireless communication apparatus according to the first aspect of the invention, and the second wireless communication apparatus according to the second aspect of the invention. Accordingly, by connecting the first wireless communication apparatus to the HDMI source apparatus, and connecting the second wireless communication apparatus to the HDMI sink apparatus, it is possible to wirelessly transmit the DDC downstream signal and the CEC downstream signal generated by the HDMI source apparatus, and wirelessly transmits the DDC upstream signal, and the CEC upstream signal generated by the HDMI sink apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI source apparatus connected to the first wireless communication apparatus and the installation location of the HDMI sink apparatus connected to the second wireless communication apparatus.

The wireless transmission system according to the sixth aspect of the invention includes the first wireless communication apparatus according to the third aspect of the invention, and the second wireless communication apparatus according to the fourth aspect of the invention. Accordingly, by connecting the first wireless communication apparatus to the HDMI source apparatus, and connecting the second wireless communication apparatus to the HDMI sink apparatus, it is possible to wirelessly transmit the DDC downstream signal and the CEC downstream signal generated by the HDMI source apparatus, and wirelessly transmits the DDC upstream signal, and the CEC upstream signal generated by the HDMI sink apparatus. Namely, by connecting the HDMI source apparatus and the HDMI sink apparatus to each other via a wireless transmission path, the connection can be realized without using any HDMI cable and simplified as compared with the prior arts. This leads to enhanced flexibility of the installation location of the HDMI source apparatus connected to the first wireless communication apparatus and the installation location of the HDMI sink apparatus connected to the second wireless communication apparatus.

1-18. (canceled)

19. A wireless communication apparatus of a first wireless communication apparatus for transmitting a transmitting signal compliant with HDMI (High Definition Multimedia Interface) standard, and for receiving a received signal compliant with the HDMI standard, the transmitting signal including a TMDS (Transition Minimized Differential Signaling) signal, a DDC (Display Data Channel) downstream signal, and a CEC (Consumer Electronics Control) downstream signal, the received signal including a DDC upstream signal and a CEC upstream signal, said wireless communication apparatus comprising:
a first wireless communication unit for wirelessly transmitting the TMDS signal as a first radio signal using a first radio channel; and
a second wireless communication unit for wirelessly transmitting the DDC downstream signal and the CEC downstream signal as a second radio signal using a second radio channel, and for receiving a third radio signal including the DDC upstream signal and the CEC upstream signal using the second radio channel,
wherein said second wireless communication unit comprises a first time division multiplexing and demultiplexing unit for time-division-multiplexing the DDC downstream signal and the CEC downstream signal into the second radio signal, and for time-division-demultiplexing the third radio signal into the DDC upstream signal and the CEC upstream signal.

20. The wireless communication apparatus as claimed in claim 19,
wherein said first time division multiplexing and demultiplexing unit time-division-multiplexes the DDC downstream signal and the CEC downstream signal into the second radio signal with giving priority to the DDC downstream signal over the CEC downstream signal, so as to wirelessly transmit the DDC downstream signal prior to the CEC downstream signal.

21. The wireless communication apparatus as claimed in claim 19,
wherein, in either one of (a) a case where the DDC downstream signal includes a readout request signal for EDID (Extended Display Identification Data) information, and (b) a case where the DDC downstream signal includes a downstream signal of HDCP (High-Bandwidth Digital Content Protection) authentication processing based on the HDMI standard, said first time division multiplexing and demultiplexing unit time-division-multiplexes the DDC downstream signal and the CEC downstream signal into the second radio signal with giving priority to the DDC downstream signal over the CEC downstream signal, so as to wirelessly transmit the DDC downstream signal prior to the CEC downstream signal.

22. The wireless communication apparatus as claimed in claim 19,
wherein said first wireless communication unit wirelessly transmits a TMDS radio test signal including a predetermined reference pattern to a second wireless communication apparatus as the first radio signal using the first radio channel,
wherein said second wireless communication unit receives a first estimation value relating to a first received state of the TMDS radio test signal detected by said second wireless communication apparatus as the third radio signal using the second radio channel, and
wherein said first wireless communication apparatus further comprises a controller for adjusting transmitting parameters of the first radio signal based on the first estimation value, so as to make the first received state substantially best.

23. The wireless communication apparatus as claimed in claim 22,
wherein said second wireless communication unit wirelessly transmits a DDC/CEC radio test signal including a predetermined reference pattern to said second wireless communication apparatus as the second radio signal using the second radio channel, and receives a second estimation value relating to a second received state of the DDC/CEC radio test signal detected by said second wireless communication apparatus as the third radio signal using the second radio channel, and
wherein, upon detecting that the second received state is a predetermined state based on the second estimation value, said controller controls said first wireless communication unit to wirelessly transmit the TMDS radio test signal to said second wireless communication apparatus as the first radio signal using the first radio channel.

24. The wireless communication apparatus as claimed in claim 22,
wherein, upon detecting that the first received state substantially becomes best based on the first estimation value, said controller controls a signal source apparatus which generates the TMDS signal, the DDC downstream signal, and the CEC downstream to start communication with a signal sink apparatus which generates the DDC upstream signal and the CEC upstream signal.

25. A wireless communication apparatus of a second wireless communication apparatus for receiving a received signal compliant with HDMI (High Definition Multimedia Interface) standard, and for transmitting a transmitting signal compliant with the HDMI standard, the received signal including a TMDS (Transition Minimized Differential Signaling) signal, a DDC (Display Data Channel) downstream signal, and a CEC (Consumer Electronics Control) downstream signal, the transmitted signal including a DDC upstream signal and a CEC upstream signal, said wireless communication apparatus comprising:
a third wireless communication unit for receiving the TMDS signal as a first radio signal using a first radio channel; and
a fourth wireless communication unit for receiving a second radio signal including the DDC downstream signal and the CEC downstream signal using a second radio channel, and for wirelessly transmitting the DDC upstream signal and the CEC upstream signal as a third radio signal using the second radio channel,
wherein said fourth wireless communication unit comprises a second time division multiplexing and demultiplexing unit for time-division-demultiplexing the second radio signal into the DDC downstream signal and the CEC downstream signal, and for time-division-multiplexing the DDC upstream signal and the CEC upstream signal into the third radio signal.

26. The wireless communication apparatus as claimed in claim 25,
wherein said second time division multiplexing and demultiplexing unit time-division-multiplexes the DDC upstream signal and the CEC upstream signal into the third radio signal with giving priority to the DDC upstream signal over the CEC upstream signal, so as to wirelessly transmit the DDC upstream signal prior to the CEC upstream signal.

27. The wireless communication apparatus as claimed in claim 25,
wherein, in either one of (a) a case where the DDC upstream signal includes EDID (Extended Display Identification Data) information, and (b) a case where the DDC upstream signal includes an upstream signal of HDCP (High-Bandwidth Digital Content Protection) authentication processing based on the HDMI standard, said second time division multiplexing and demultiplexing unit time-division-multiplexes the DDC upstream signal and the CEC upstream signal into the third radio signal with giving priority to the DDC upstream signal over the CEC upstream signal, so as to wirelessly transmit the DDC upstream signal prior to the CEC upstream signal.

28. The wireless communication apparatus as claimed in claim 25,
wherein said third wireless communication unit receives the first radio signal including a TMDS radio test signal including a predetermined reference pattern using the first radio channel,
wherein said second wireless communication apparatus further comprises a controller for detecting and outputting a first estimation value relating to a first received state of the TMDS radio test signal, and
wherein said fourth wireless communication unit wirelessly transmits the first estimation value as the third radio signal using the second radio channel.

29. The wireless communication apparatus as claimed in claim 28,
wherein said fourth wireless communication unit receives the second radio signal including a DDC/CEC radio test signal including a predetermined reference pattern using the second radio channel,
wherein said controller detects and outputs a second estimation value relating to a second received state of the DDC/CEC radio test signal, and
wherein said fourth wireless communication unit wirelessly transmits the second estimation value as the third radio signal using the second radio channel.

30. A wireless communication apparatus of a first wireless communication apparatus for transmitting a transmitting signal compliant with HDMI (High Definition Multimedia Interface) standard, and for receiving a received signal compliant with the HDMI standard, the transmitting signal including a TMDS (Transition Minimized Differential Signaling) signal, a DDC (Display Data Channel) downstream signal, and a CEC (Consumer Electronics Control) downstream signal, the received signal including a DDC upstream signal and a CEC upstream signal, said wireless communication apparatus comprising:
a first wireless communication unit for wirelessly transmitting the TMDS signal, the DDC downstream signal, and the CEC downstream signal as a first radio signal using a first radio channel; and
a second wireless communication unit for receiving a second radio signal including the DDC upstream signal and the CEC upstream signal using a second radio channel.

31. The wireless communication apparatus as claimed in claim 30,
wherein the TMDS signal includes a digital video signal, a digital audio signal, and auxiliary data, and
wherein said first wireless communication unit comprises a time division multiplexing and demultiplexing unit for multiplexing the DDC downstream signal and the CEC downstream signal for a blanking interval of the digital video signal, so as not to overlap the DDC downstream signal and the CEC downstream signal on the digital audio signal and the auxiliary data, to time-division-multiplex the TMDS signal, the DDC downstream signal, and the CEC downstream signal into the first radio signal.

32. A wireless communication apparatus of a second wireless communication apparatus for receiving a received signal compliant with HDMI (High Definition Multimedia Interface) standard, and for transmitting a transmitting signal compliant with the HDMI standard, the received signal including a TMDS (Transition Minimized Differential Signaling) signal, a DDC (Display Data Channel) downstream signal, and a CEC (Consumer Electronics Control) downstream signal, the transmitted signal including a DDC upstream signal and a CEC upstream signal, said wireless communication apparatus comprising:
a third wireless communication unit for receiving a first radio signal including the TMDS signal, the DDC downstream signal, and the CEC downstream signal using a first radio channel; and
a fourth wireless communication unit for wirelessly transmitting the DDC upstream signal and the CEC upstream signal as a second radio signal using a second radio channel.

33. A wireless transmission system comprising:
a first wireless communication apparatus for transmitting a transmitting signal compliant with HDMI (High Definition Multimedia Interface) standard, and for receiving a received signal compliant with the HDMI standard, the transmitting signal including a TMDS (Transition Minimized Differential Signaling) signal, a DDC (Display Data Channel) downstream signal, and a CEC (Consumer Electronics Control) downstream signal, the received signal including a DDC upstream signal and a CEC upstream signal; and
a second wireless communication apparatus for receiving a received signal compliant with HDMI standard, and for transmitting a transmitting signal compliant with the HDMI standard, the received signal including the TMDS signal, the DDC, and the CEC downstream signal, the transmitted signal including the DDC upstream signal and the CEC upstream signal,
wherein said first wireless communication apparatus comprises:
a first wireless communication unit for wirelessly transmitting the TMDS signal as a first radio signal using a first radio channel; and
a second wireless communication unit for wirelessly transmitting the DDC downstream signal and the CEC downstream signal as a second radio signal using a second radio channel, and for receiving a third radio signal including the DDC upstream signal and the CEC upstream signal using the second radio channel,
wherein said second wireless communication apparatus comprises:
a third wireless communication unit for receiving the TMDS signal as the first radio signal using the first radio channel; and
a fourth wireless communication unit for receiving the second radio signal including the DDC downstream signal and the CEC downstream signal using the second radio channel, and for wirelessly transmitting the DDC upstream signal and the CEC upstream signal as the third radio signal using the second radio channel,
wherein said second wireless communication unit comprises a first time division multiplexing and demultiplexing unit for time-division-multiplexing the DDC downstream signal and the CEC downstream signal into the second radio signal, and for time-division-demultiplexing the third radio signal into the DDC upstream signal and the CEC upstream signal, and
wherein said fourth wireless communication unit comprises a second time division multiplexing and demultiplexing unit for time-division-demultiplexing the second radio signal into the DDC downstream signal and the CEC downstream signal, and for time-division-multiplexing the DDC upstream signal and the CEC upstream signal into the third radio signal.

34. A wireless transmission system comprising:
a first wireless communication apparatus for transmitting a transmitting signal compliant with HDMI (High Definition Multimedia Interface) standard, and for receiving a received signal compliant with the HDMI standard, the transmitting signal including a TMDS (Transition Minimized Differential Signaling) signal, a DDC (Display Data Channel) downstream signal, and a CEC (Consumer Electronics Control) downstream signal, the received signal including a DDC upstream signal and a CEC upstream signal; and
a second wireless communication apparatus for receiving a received signal compliant with HDMI standard, and for transmitting a transmitting signal compliant with the HDMI standard, the received signal including the TMDS signal, the DDC, and the CEC downstream signal, the transmitted signal including the DDC upstream signal and the CEC upstream signal,
wherein said first wireless communication apparatus comprises:
a first wireless communication unit for wirelessly transmitting the TMDS signal, the DDC downstream signal, and the CEC downstream signal as a first radio signal using a first radio channel; and
a second wireless communication unit for receiving a second radio signal including the DDC upstream signal and the CEC upstream signal using a second radio channel, and
wherein said second wireless communication apparatus comprises:
a third wireless communication unit for receiving a first radio signal including the TMDS signal, the DDC downstream signal, and the CEC downstream signal using a first radio channel; and
a fourth wireless communication unit for wirelessly transmitting the DDC upstream signal and the CEC upstream signal as a second radio signal using a second radio channel.
